(19) United States
(12) Patent Application Publication
(10) Pub. No.: US 2025/0341434 A1
(43) Pub. Date: Nov. 6, 2025

(54) STRAIN DETECTION DEVICE

(71) Applicant: Japan Display Inc., Tokyo (JP)

(72) Inventors: Toshinori UEHARA, Tokyo (JP); Fumihoru NAKANO, Tokyo (JP)

(21) Appl. No.: 19/271,370

(22) Filed: Jul. 16, 2025

Related U.S. Application Data
(63) Continuation of application No. PCT/JP2023/040752, filed on Nov. 13, 2023.

(30) Foreign Application Priority Data
Jan. 17, 2023 (JP) 2023-005121

(51) Int. Cl. G01L 1/22; G01L 1/20

(52) U.S. Cl. CPC G01L 1/225; G01L 1/205

(57) ABSTRACT

According to one embodiment, a strain detection device includes a plurality of strain gauges arranged in a row, a power line, a ground line, a first signal line, and a second signal line each extending along the row of the strain gauges, a plurality of first open/close switches each connected between the one end of each of the strain gauges and the power supply line, a plurality of second open/close switches each connected between of the other end of each of the strain gauges and the ground line, a plurality of third open/close switches each connected between the one end of each of the strain gauges and the first signal line, and a plurality of fourth open/close switches each connected between the other end of each of the strain gauges and the second signal line.

### CROSS-REFERENCE TO RELATED APPLICATIONS

This application is a Continuation Application of PCT Application No. PCT/JP2023/040752, filed Nov. 13, 2023 and based upon and claiming the benefit of priority from Japanese Patent Application No. 2023-005121, filed Jan. 17, 2023, the entire contents of all of which are incorporated herein by reference.

### FIELD

Embodiments described herein relate generally to a strain detection device.

### BACKGROUND

As an example of the strain detection device, a flexible film-shaped or sheet-shaped strain gauge sensor is known. The strain gauge sensor includes a plurality of strain gauges aligned on a belt-shaped flexible sheet material, and a plurality of signal lines for electrically connecting to the strain gauges. The strain gauge sensor is placed around on a curved test object and the resistance values of the strain gauges are detected, and thus the curved shape of the test object can be detected.

In conventional strain gauge sensors, strain detection is performed by applying power to all of strain gauges. Therefore, strain gauge sensors tend to consume a large amount of power for detection. Further, in the above-described strain gauge sensor, signal lines are connected individually to all strain gauges. With this configuration, the area occupied by the wiring is large, which hinders the miniaturization of the sensor.

### BRIEF DESCRIPTION OF THE DRAWINGS

FIG. 1 is a perspective view of a strain gauge sensor device according to the first embodiment.

FIG. 2 is a plan view schematically showing a gauge pattern and wiring pattern of the strain gauge sensor device.

FIG. 3 is a plan view showing a sensor sheet of the strain gauge sensor device.

FIG. 4 is a cross-sectional view of the sensor sheet taken along the line A-A in FIG. 3.

FIG. 5 is a cross-sectional view of the sensor sheet taken along the line B-B in FIG. 3.

FIG. 6 is a block diagram of a controller of the strain gauge sensor device.

FIG. 7 is a circuit diagram of a differential detection circuit in an analog front end of the controller.

FIG. 8 is a timing chart of various signals during a sleep mode of the strain gauge sensor device.

FIG. 9 is a timing chart of various signals during an active mode of the strain gauge sensor device.

FIG. 10 is a schematic diagram showing a part of the strain gauge sensor device when installed on the surface of a test object.

FIG. 11 is a schematic diagram showing an equivalent circuit of the sensor sheet.

FIG. 12 is a plan view showing a sensor sheet of a strain gauge sensor device according to the second embodiment.

FIG. 13 is a cross-sectional view of the sensor sheet taken along the line C-C in FIG. 12.

FIG. 14 is a cross-sectional view of the sensor sheet taken along line D-D in FIG. 12.

FIG. 15 is a perspective view of a strain gauge sensor device according to the third embodiment.

FIG. 16 is a perspective view schematically showing a base end portion of the sensor sheet and an intermediate board in the strain gauge sensor device according to the third embodiment.

FIG. 17 is a plan view schematically showing gauge patterns and wiring patterns of the first sensor sheet and the second sensor sheet in the strain gauge sensor device according to the third embodiment.

FIG. 18 is a block diagram of a controller of the strain gauge sensor device according to the third embodiment.

FIG. 19 is a circuit diagram of a differential detection circuit included in an analog front end of the controller.

FIG. 20 is a timing chart of various signals during a sleep mode of the strain gauge sensor device according to the third embodiment.

FIG. 21 is a timing chart of various signals during an active mode of the strain gauge sensor device according to the third embodiment.

FIG. 22 is a schematic diagram showing a part of the strain gauge sensor device when installed on the surface of a test object.

FIG. 23 is a schematic diagram showing equivalent circuits of the first sensor sheet and the second sensor sheet.

FIG. 24 is a plan view schematically showing gauge patterns and wiring patterns of the first sensor sheet and the second sensor sheet in a strain gauge sensor device according to the fourth embodiment.

FIG. 25 is a plan view schematically showing gauge patterns and wiring patterns of the first sensor sheet and the second sensor sheet in a strain gauge sensor device according to the fifth embodiment.

FIG. 26 is a plan view schematically showing gauge patterns and wiring patterns of the first sensor sheet and the second sensor sheet in a strain gauge sensor device according to the sixth embodiment.

### DETAILED DESCRIPTION

Various embodiments will be described hereinafter with reference to the accompanying drawings. In general, according to one embodiment, the strain detection device comprises a plurality of strain gauges having one end and an other end and arranged in a row at intervals, power lines, ground lines, first signal lines, and second signal lines extending along the row of the plurality of strain gauges, a plurality of first open/close switches connected between the one end of a corresponding one of the plurality of strain gauges and the power lines, a plurality of second switches connected between the other end of a corresponding one of the plurality of strain gauges and the ground line, a plurality of third switches connected between the one end of a corresponding one of the plurality of strain gauges and the first signal line, and a plurality of fourth switches connected between the other end of a corresponding one of the plurality of strain gauges and the second signal line.

Embodiments will now be described in detail with reference to the accompanying drawings.

Note that the disclosure is merely an example, and any appropriate modifications that are easily conceivable by those skilled in the art while maintaining the essence of the invention are naturally included in the scope of the present invention. In addition, the drawings are provided to clarify the explanation, and the width, thickness, shape, etc., of each part may be represented schematically compared to the actual configuration, but these are merely examples and do not limit the interpretation of the present invention. Furthermore, in this specification and the figures, the same reference numerals are used for elements previously described in relation to the preceding figures, and detailed descriptions may be omitted or simplified as appropriate.

### First Embodiment

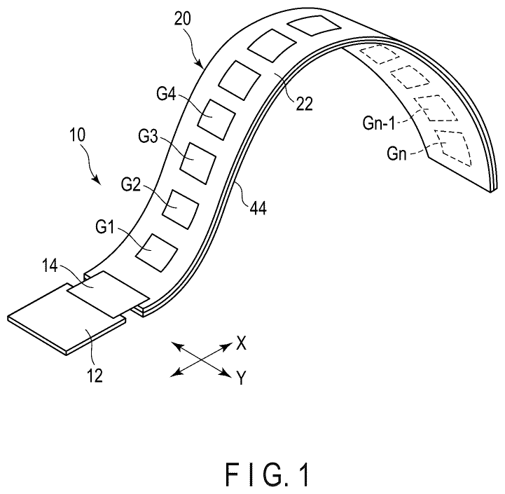

As an example of the strain detection device, a strain gauge sensor device according to the first embodiment will be described in detail. FIG. 1 is a perspective view of the strain gauge sensor device according to the first embodiment.

As shown in the figure, a strain gauge sensor device 10 according to the first embodiment constitutes a single-sided strain gauge sensor. The strain gauge sensor device 10 includes a slender strip-shaped flexible base substrate 44, a sensor sheet 20 attached to one side of the base substrate 44, and an intermediate board (drive circuit board) 12 connected to the sensor sheet 20 via a flexible printed circuit board (FPC) 14. In one example, the base substrate 44 is formed from a resin such as polyethylene terephthalate (PET) or polyimide to have a thickness of approximately 0.3 to 0.5 mm.

The sensor sheet 20 includes a slender strip-shaped flexible sheet substrate 22 and a conductor pattern provided on one side of the sheet substrate 22. The conductor pattern includes a plurality of strain gauges G1 to Gn. These strain gauges G1 to Gn are provided to be aligned in a single row in a longitudinal direction X at predetermined intervals from one end of the sheet substrate 22 in the longitudinal direction X over to the other end thereof.

Note that in the figure, the longitudinal direction X and width direction Y of the sensor sheet 20 indicate two directions orthogonal to each other. These directions may intersect at angles other than 90 degrees.

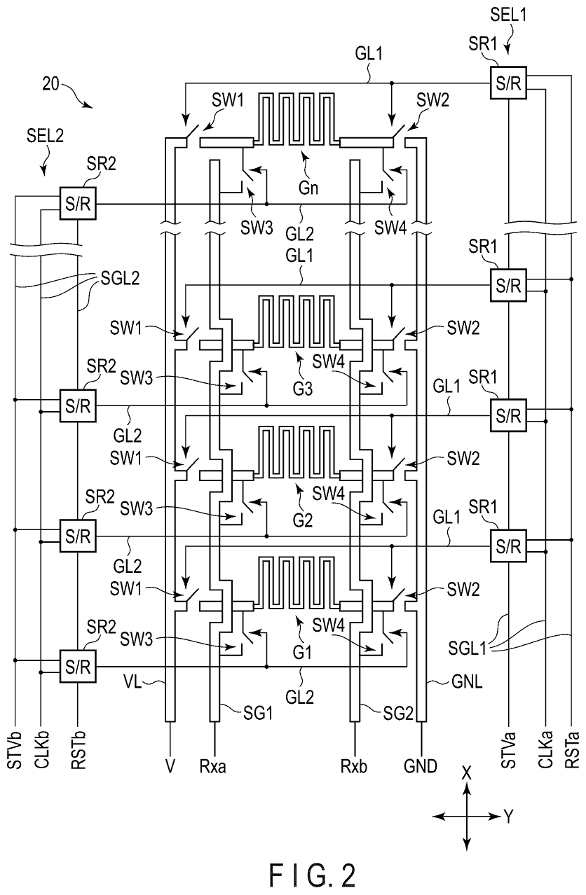

FIG. 2 is a plan view schematically showing a strain gauge and wiring pattern of the sensor sheet 20. As shown in the figure, the conductor pattern of the sensor sheet 20 includes a plurality of strain gauges G1 to Gn. These strain gauges G1 to Gn are provided in a single row at intervals in the longitudinal direction X of the sensor sheet 20. Each of the strain gauges G1 to Gn extends in a bellows manner in the width direction Y and has one end and the other end in the width direction Y. Each of the strain gauges G1 to Gn exhibits a resistance change in response to strain.

The conductor pattern includes a power supply line VL, a ground line GN, a first signal line SG1, and a second signal line SG2, each extending in the longitudinal direction X along the row of strain gauges G1 to Gn. The first signal line SG1 and the power supply line VL are located on the side of one end of each of the strain gauges G1 to Gn, and further, the power supply line VL is spaced apart from the first signal line SG1 on an outer side thereof in the width direction Y. The second signal line SG2 and the ground line GN are located on the other side of the strain gauges G1 to Gn, and further, the ground line GN is spaced apart from the second signal line SG2 on an outer side thereof in the width direction Y.

One end of each of the strain gauges G1 to Gn is connected to the power line VL via a respective first open/close switch SW1. The other end of each of the strain gauges G1 to Gn is connected to the ground line GNL via a respective second open/close switch SW2. Further, one end of each of the strain gauges G1 to Gn is connected to the first signal line SG1 via a respective third open/close switch SW3. The other end of each of the strain gauges G1 to Gn is connected to the second signal line SG2 via a respective open/close fourth switch SW4.

The sensor sheet 20 includes a first selector SEL1 for switching the first open/close switch SW1 and the second open/close switch SW2 of the respective one of the strain gauges G1 to Gn, and a second selector SEL2 for switching the third open/close switch SW3 and the fourth open/close switch SW4 of the respective one of the strain gauges G1 to Gn. The first selector SEL1 includes a plurality of shift registers (S/R) SR1 arranged in the longitudinal direction X aside the ground line GNL and corresponding to the strain gauges G1 to Gn, respectively, three signal lines SGL1 for inputting signals (RSTa, CLKa, STVa) to these shift registers SR1, and gate lines GL1 each for inputting the output signal of the respective shift register SR1 to the corresponding first open/close switch SW1 and the second open/close switch SW2.

The second selector SEL2 includes a plurality of shift registers (S/R) SR2 arranged in the longitudinal direction X aside the power supply line VL and corresponding to the strain gauges G1 to Gn, respectively, three signal lines SGL2 for inputting signals (RSTb, CLKb, STVb) to these shift registers SR2, and gate lines GL2 each for inputting the output signal of the respective shift register SR2 to the corresponding third open/close switch SW3 and fourth open/close switch SW4.

The wiring structure of the sensor sheet will now be described in detail.

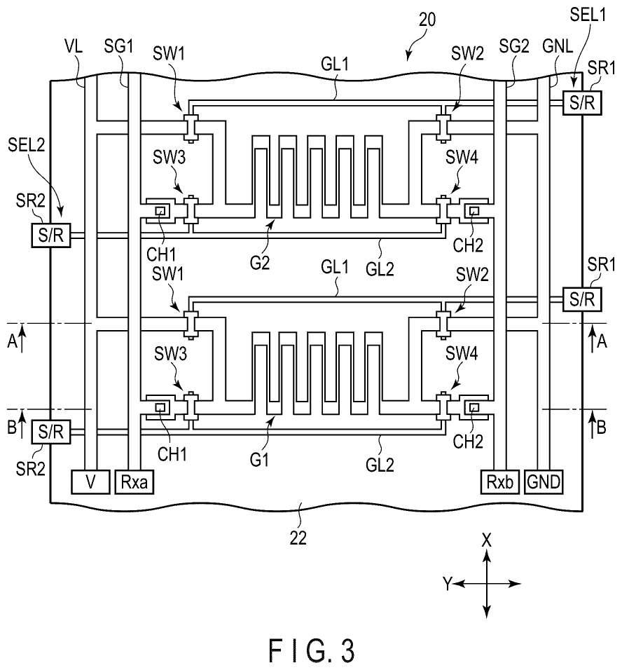

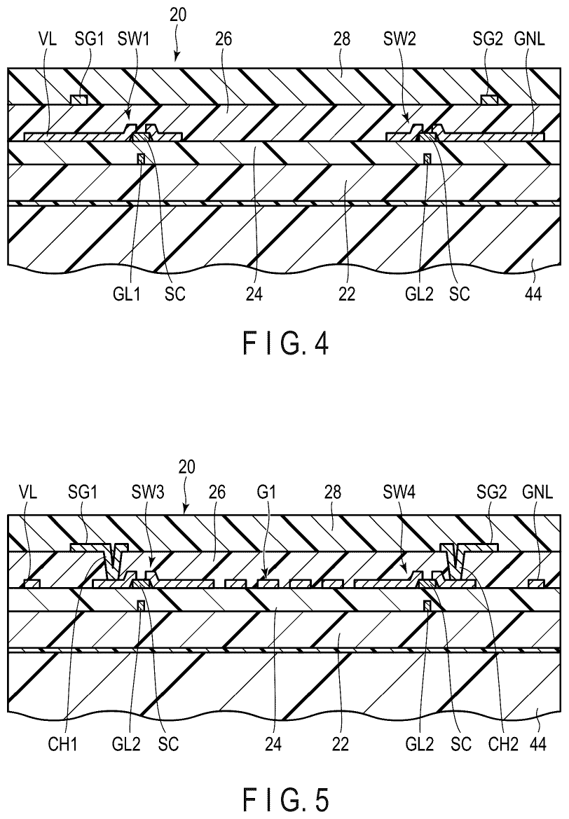

FIG. 3 is a plan view showing the wiring structure of the sensor sheet in more detail, FIG. 4 is a cross-sectional view of the sensor sheet taken along the line A-A in FIG. 3, and FIG. 5 is a cross-sectional view of the sensor sheet taken along the line B-B in FIG. 3.

As shown in FIGS. 3 and 4, in the sensor sheet 20, the gate lines GL1 and GL2 are provided on the surface of the sheet substrate 22. While overlaid on the gate lines GL1 and GL2, an interlayer film 24 is stacked on the surface of the sheet substrate 22. On top of the interlayer film 24, semiconductor layers SC and a conductive layer are formed. The conductive layer forms the wiring patterns of the strain gauges G1 to Gn, the power supply line VL, and the ground line GNL. Each of the semiconductor layers SC faces a respective gate formed of the respective gate lines GL1 and GL2, while interposing the interlayer film 24 therebetween. The branch wiring lines that branch from the power supply line VL and each connects to one end of the respective one of the strain gauges G is cut in a middle, and an end portion of the cut side of each branched wiring line is located to overlap the respective semiconductor layer SC, thus forming a source electrode or a drain electrode. With this configuration, a gate, a respective semiconductor layer SC, a respective source electrode, and a respective drain electrode form each of thin-film transistors (TFT). These TFTs constitute the first open/close switch SW1, the second open/close switch SW2, the third open/close switch SW3, and the fourth open/close switch SW4, respectively.

Overlaid on the conductive layer, an interlayer film 26 is stacked on top of the interlayer film 24. On top of the interlayer film 26, the first and second signal lines SG1 and SG2 are formed and further, a protective film 28 is stacked on top of the interlayer film 26, which is overlaid on the first and second signal lines SG1 and SG2. The branch wiring lines branching from multiple locations of the first signal line SG1 are each connected to one end of the respective strain gauge G via a respective contact hole CH1. That is, the first signal line SG1 is connected to one end of each strain gauge G via the respective contact hole CH1, branch wiring line, and third open/close switch SW3. Similarly, branch wiring lines branching from multiple locations of the second signal line SG2 are each connected to the other end of the respective strain gauge G via a contact hole CH2. That is, the second signal line SG2 is connected to the other end of each strain gauge G via the respective contact hole CH2, branch wiring line, and fourth open/close switch SW4.

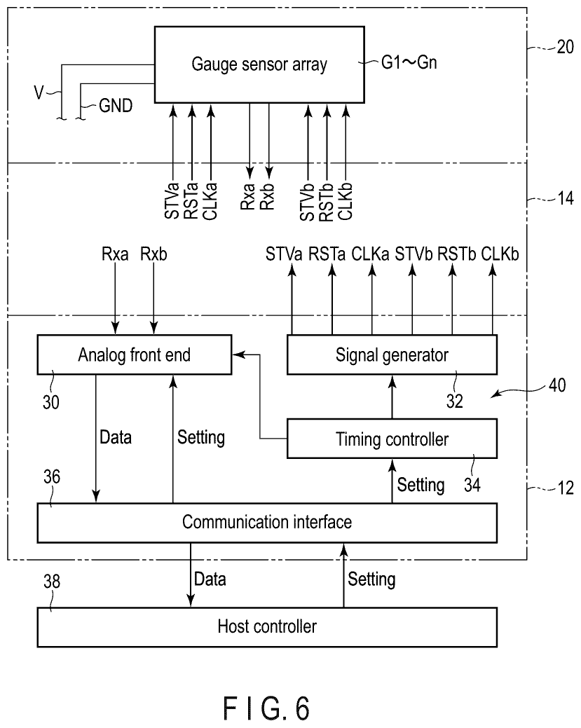

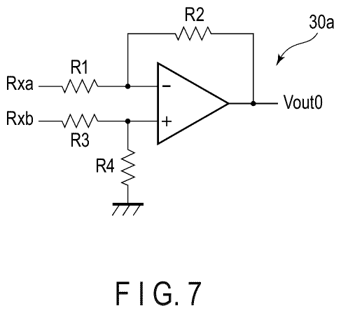

Next, the drive circuit (controller) for driving the sensor sheet 20 configured as described above will be described. FIG. 6 is a block diagram schematically showing the drive circuit (controller) of the strain gauge sensor device 10, and FIG. 7 is a circuit diagram of a differential detection circuit at an analog front end.

As shown in FIG. 6, the drive circuit 40 provided on the intermediate board (drive circuit board) 12 includes an analog front end (AFE: signal adjustment circuit) 30, a signal generator 32, a timing controller 34, a communication interface 36, and the like.

The communication interface 36 is connected to an external host controller 38 wirelessly or via wire, to receive drive signals (setting) from the host controller 38, and transmit detection data (Data) to the host controller 38.

The timing controller 34 outputs drive signals to the signal generator 32 and the analog front end 30 in response to the drive signals (setting).

The signal generator 32 generates a clock signal CLKa, a reset signal RSTa, and a data signal STVa in response to the drive signal from the timing controller 34, and inputs each of the signals CLKa, RSTa, and STVa to the shift register SR1. At the same time, the signal generator 32 generates a clock signal CLKb, a reset signal RSTb, and a data signal STVb, and inputs each of the signals CLKb, RSTb, and STVb to the shift register SR2.

The analog front end 30 includes a readout circuit, an A/D converter, a digital filter, and the like. As shown in FIG. 7, according to this embodiment, the analog front end 30 includes a differential detection circuit (subtraction circuit) 30a. The analog front end 30 adjusts (amplifies, AD-converts, and filters) the detection signals RXa and RXb sent from each of the strain gauges G1 to Gn in response to the drive signal and outputs them to the communication interface 36. In this case, since the voltage drop value of each of the strain gauges G is required for calculating the curvature radius, the difference detection circuit 30a takes the difference between the detection values Rx a and Rx b of the strain gauges G1 to Gn and outputs the signals.

The host controller 38 reads the output signals (data) sent from the communication interface 36, performs data shaping, arithmetic processing including curved surface calculation, and the like, and calculates out the strain, the shape of the curved surface, and the like of the test object detected by the sensor sheet 20.

Next, the operation mode of the strain gauge sensor device 10 will be described.

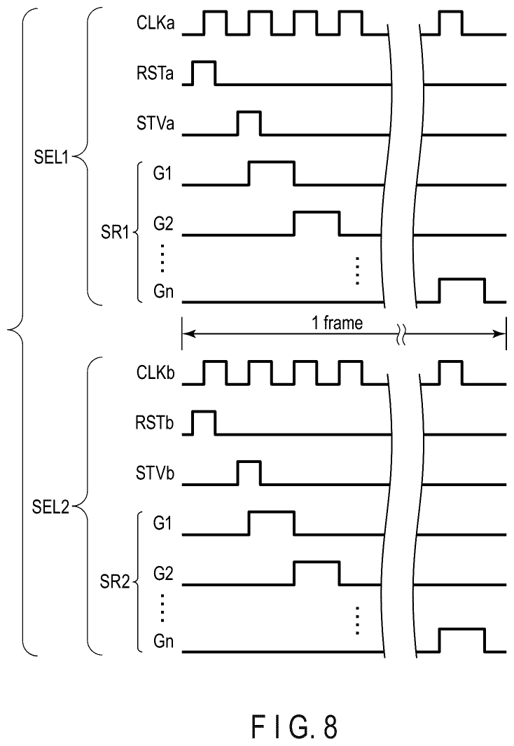

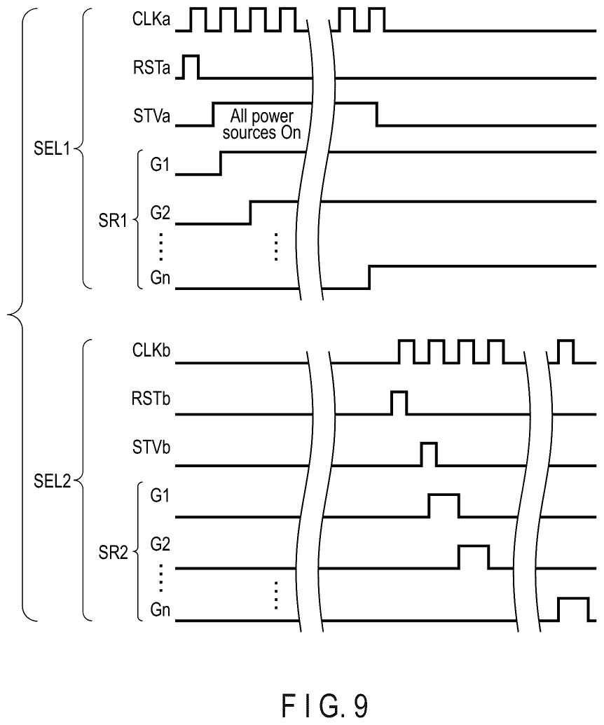

FIG. 8 is a timing chart showing signal output when operating in a sleep mode (first operation mode), and FIG. 9 is a timing chart showing signal output when operating in an active mode (second operation mode).

As shown in FIG. 8, in the sleep mode, power and signal lines are scanned and driven to sequentially supply voltage to the strain gauges G1 to Gn and sequentially read the detection values of the strain gauges G1 to Gn. In detail, in response to instructions from the host controller 38, the drive circuit 40 inputs a clock signal CLKa to all shift registers SR1. Further, the drive circuit 40 inputs a reset signal RSTa to all shift registers SR1 in synchronization with the clock signal CLKa. Thus, all the shift registers SR1 of the first selector SEL1 are reset. After that, the drive circuit 40 inputs a data signal STVa, which serves as a start pulse for the shift registers, into the shift register SR1 of the first stage (, that is, the shift register corresponding to the strain gauge G1). With this operation, the first-stage shift register SR1 outputs an on signal to the first open/close switch SW1 and the second open/close switch SW2 for a certain period of time, so as to turn on (close) the first open/close switch SW1 and the second open/close switch SW2 for a certain period of time. After a certain period of time has elapsed, the on signal is turned off, and the first open/close switch SW1 and the second open/close switch SW2 switch to off (open). While the first open/close switch SW1 and the second open/close switch SW2 are on, the strain gauge G1 is connected to the power line VL and the ground line GNL, to apply the power supply voltage thereto. Thus, current flows through the strain gauge G1 for a certain period of time.

Thereafter, an input signal is input to the second-stage shift register SR1 (the shift register corresponding to the strain gauge G2) from the first-stage shift register SR1. This input signal corresponds to the data signal STVa input to the first-stage shift register SR1, and with this signal, the second-stage shift register SR1 outputs an on signal to the first open/close switch SW1 and the second open/close switch SW2 for a certain period of time, thereby turning the first open/close switches SW1 and second open/close switch SW2 on (closed) for a certain period of time. While the first open/close switch SW1 and the second open/close switch SW2 are on, the power supply voltage is applied to the strain gauge G2, and a current flows through the strain gauge G2 for a certain period of time.

From this point on, as in the case of the operation explained so far, over one frame (the period until the next reset signal RSTa is input), the input signals described above are sequentially input to the shift registers SR1 of the first stage to the nth stage, and the respective first open/close switches SW1 and the respective second open/close switches SW2 are sequentially turned on, thereby applying the power supply voltage to the strain gauges G3 to Gn in sequence.

Further, the drive circuit 40 inputs the clock signal CLKb and the reset signal RSTb synchronized with the clock signal and the data signal STVb to the second selector SEL2 in synchronization with the scan drive of the power supply. More specifically, the drive circuit 40 inputs the clock signal CLKb to all the shift registers SR2. This clock signal CLKb is substantially the same signal as the clock signal CLKa. Further, the drive circuit 40 inputs the reset signal RSTb to all the shift registers SR2 in synchronization with the clock signal CLKb. The reset signal RSTb is synchronized with the reset signal RSTa and is supplied to all the shift registers SR2 at the same timing as that of the reset signal RSTa. With this operation, all the shift registers SR2 are reset. Subsequently, the drive circuit 40 inputs the data signal STVb to the first-stage shift register SR2 (the shift register corresponding to the strain gauge G1). The data signal STVb is synchronized with the data signal STVa and is supplied to the first-stage shift register SR2 at the same timing as that of the data signal STVa. With this operation, the first-stage shift register SR2 outputs an on signal to the third open/close switch SW3 and the fourth open/close switch SW4 at the same timing as that of the first-stage shift register SR1 for a certain period of time, to turn on (close) the third open/close switch SW3 and the fourth open/close switch SW4 for a certain period of time. After a certain time has elapsed, the on signal is turned off, and the third open/close switch SW3 and the fourth open/close switch SW4 are switched to off (open). While the third open/close switch SW3 and the fourth open/close switch SW4 are on, one end and the other end of the strain gauge G1 are connected to the first signal line SG1 and the second signal line SG2, respectively, and for a certain period of time, the detection signal (voltage value) RXa at one end of the strain gauge G1 and the detection signal (voltage value) RXb at the other end are output to the first and second signal lines SG1 and SG2, respectively. The detection signals RXa and RXb are sent to the analog front end 30 of the drive circuit 40 via the first and second signal lines SG1 and SG2, respectively.

After that, an input signal is input to the second-stage shift register SR2 (the shift register corresponding to the strain gauge G2) from the first-stage shift register SR2. This input signal corresponds to the data signal STVb input to the first-stage shift register SR2, and with this signal, the second-stage shift register SR2 outputs an on signal to the third open/close switch SW3 and the fourth open/close switch SW4 at the same timing as that of the second-stage shift register SR1, to turn on (close) the third open/close switch SW3 and the fourth open/close switch SW4 for a certain period of time. While the third open/close switch SW3 and the fourth open/close switch SW4 are on, one end and the other end of the strain gauge G2 are connected to the first signal line SG1 and the second signal line SG2, respectively, and the detection signal (voltage value) RXa at one end of the strain gauge G2 and the detection signal (voltage value) RXb at the other end are output to the first and second signal lines SG1 and SG2 for a certain period of time. The detection signals RXa and RXb are sent to the analog front end 30 of the drive circuit 40 via the first and second signal lines SG1 and SG2, respectively.

From this point on, as in the case of the operation explained so far, over one frame, the input signals described above are sequentially input to the shift registers SR2 of the first stage to the nth stage. Thus, the first open/close switch SW1 and the second open/close switch SW2 are switched sequentially to the on state, and accordingly the third open/close switch SW3 and the fourth open/close switch SW4 are sequentially switched to the on state by the shift register SR2. In this manner, the detection signals RXa and RXb from the strain gauges G3 to Gn are sequentially output to the first and second signal lines SG1 and SG2.

The detection signals RXa and RXb are sequentially sent to the analog front end 30, which are subjected to adjustment and differential detection. All of the detection signals RXa and RXb subjected to the adjustment and difference-detection are collectively sent to the communication interface 36 and then sent to the host controller 38 via the communication interface 36. Note that the above-provided expression “same timing” used here means not only exactly the same timing but also timing that is slightly offset to the extent that it can be regarded as the same timing for the drive of the present embodiment.

In the sleep mode described above, current is supplied only to the strain gauges G subjected to scanning, and therefore the sensor power consumption during strain detection can be reduced compared to the case where the power of all the strain gauges G1 to Gn is on at all times.

On the other hand, as shown in FIG. 9, in the active mode (second operation mode), after setting all the strain gauges G1 to Gn to the one state, only the signal lines SG1 and SG2 are scanned and driven. With this operation, the detection values of the strain gauges G1 to Gn are read sequentially. In more detail, in response to instructions from the host controller 38, the drive circuit 40 outputs a clock signal CLKa to each of the shift registers SR1. The drive circuit 40 also outputs a reset signal RSTa synchronized with the clock signal CLKa to all the shift registers SR1. With this operation, all the shift registers SR1 of the first selector SEL1 are reset. Subsequently, a data signal STVa is input to the first-stage shift register SR1 (shift register corresponding to the strain gauge G1). The first-stage shift register SR1 is maintained at the on level during the frame (until the next reset signal is input) by the data signal STVa. As the input signal corresponding to the data signal STVa is sequentially supplied to the shift registers SR1 of the next stage, each of the shift registers SR1 from the first stage to the final stage sequentially outputs the on signal to the first open/close switch SW1 and the second open/close switch SW2, and the state where the on signal is output is maintained. With this operation, the first open/close switch SW1 and the second open/close switch SW2 connected to each of the shift registers SR1 are sequentially turned on (closed), and the on state is maintained. While the first open/close switch SW1 and the second open/close switch SW2 are on, each of the strain gauges G1 to Gn is connected to the power supply line VL and the ground line GNL, and the power supply voltage is applied. Thus, current flows through the strain gauges G1 to Gn.

After all the first open/close switches SW1 and second open/close switches SW2 are turned on, the drive circuit 40 inputs a clock signal CLKb to all the shift registers SR2. Further, the drive circuit 40 inputs a reset signal RSTb synchronized with the clock signal to all the shift registers SR2. Thereafter, the drive circuit 40 inputs the data signal STVb into the first-stage shift register SR2. With this operation, each of the shift registers SR2 sequentially outputs an on signal to the third open/close switch SW3 and the fourth open/close switch SW4, to switch the third open/close switch SW3 and the fourth open/close switch SW4 to the on state (close) for a predetermined time. Using the data signal STVb as a start pulse, the strain gauges G1 to Gn are sequentially connected to the first and second signal lines SG1 and SG2, and the detection values (detection signals) RXa and RXb at the respective ends of the strain gauges are output to the first and second signal lines SG1 and SG2 at regular intervals. The detection signals RXa and RXb are sent to the analog front end 30 of the drive circuit 40 via the first and second signal lines SG1 and SG2. The detection signals RXa and RXb are adjusted by the analog front end 30 and then sent to the host controller 38 via the communication interface 36.

In the above-described active mode, while the drive circuit 40 is receiving detection signals from the strain gauges G1 to Gn, all of the first open/close switches SW1 and the second open/close switches SW2 are maintained in the on state. Therefore, the variation in parasitic capacitance in the power line VL and the ground line GNL is smaller as compared to that in the sleep mode, and the response speed of the strain gauge sensor becomes faster.

Next, a method for calculating the curvature radius of a test object using a single-sided strain gauge sensor will be described.

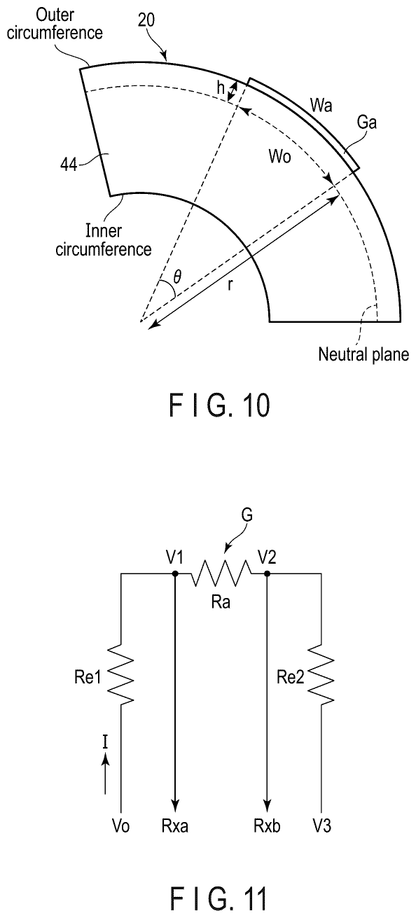

FIG. 10 is a schematic diagram showing a part of a strain gauge sensor device in a curved state as it is placed on a circumferential surface of the test object. As shown in the figure, in the curved state, the neutral plane of the base substrate 44 is curved with the same curvature radius r as the circumferential surface of the test object. Here, the neutral plane is the surface that does not elongate or contract between before and after the bending of the strain gauge sensor (that is, the strain remains zero after bending), and it is assumed that the surface is located to be apart from the outer circumferential surface (upper surface) of the base substrate 44 by a distance h. Note that when considering only the base substrate 44, the neutral plane would be located at a position corresponding to half the thickness of the base substrate 44. However, in this embodiment, a sensor sheet 20 is provided on one side of the base substrate 44, and the neutral plane is set by considering the sensor sheet 20 as well, and therefore the neutral plane is also shifted toward the side where the sensor sheet is placed.

In the equations shown in FIG. 10 and below, W0 represents the initial width of the strain gauge, Wa represents the width of the strain gauge on the outer circumferential side, ΔW represents the change in width of the strain gauge, θ represents the opening angle of the strain gauge, r represents the curvature radius of the neutral plane, k represents the gauge factor, R0 represents the reference resistance of the strain gauge, and ΔR represents the change in resistance of the strain gauge.

When the width of the strain gauge G on the neutral plane of the base substrate 44 is set to the initial width W0 of the strain gauge, W0=rθ is established. The strain gauge G on the outer circumferential side deforms into an elongated state due to bending, thereby causing the strain gauge resistance value to change by ΔR from the reference resistance R0. Here, the gauge width Wa after deformation is given by:

$${W}_{a} = {W}_{0} + Δ W = ( r + h ) θ = ( r + h ) \frac{{W}_{0}}{r}$$

The curvature radius r of the neutral plane (corresponding to the circumferential surface of the test object) is given by:

$$r = h \frac{{W}_{0}}{Δ W} = k h \frac{{R}_{0}}{Δ R} \qquad ( 1 )$$

FIG. 11 is a schematic diagram showing an equivalent circuit of the sensor sheet 20.

As shown in the figure, during strain detection, voltage drops are measured at one end and the other end of each of the strain gauges G.

When the reference resistance value of the strain gauge G before deformation is represented by R0, the resistance value of the strain gauge G after deformation is represented by Ra, the voltage values at one end and the other end of the strain gauge G are represented by V1 and V1, respectively, the resistance change of the strain gauge G is represented by ΔR, and the current flowing through the strain gauge G is represented by I. Then, the voltage drop V12 between one end and the other end of the strain gauge G is expressed by:

$${V}_{12} = {V}_{1} - {V}_{2} = Ra \cdot I$$

Here, if Ra is expressed using the change in gauge resistance as follows, the change rate of the strain resistance can be calculated.

$$\begin{matrix}\frac{{V}_{12}}{I} = {R}_{0} + Δ R \\ \frac{Δ R}{{R}_{0}} = \frac{{V}_{12} - {R}_{0} I}{{R}_{0} I}\end{matrix}$$

Therefore, substituting the above relationship into the above-provided calculation equation (1) for the curvature radius r, the curvature radius r is calculated using the following equation.

$$r = kh \cdot \frac{{R}_{0}}{Δ R} = kh \cdot \frac{{R}_{0} I}{{V}_{12} - {R}_{0} I} \qquad ( 2 )$$

In the above-provided equation (2), since the current I is easier to handle as a fixed value, it is desirable to use a constant current source as the power supply for the strain gauge sensor. Further, it is desirable to measure the reference resistance RO of the strain gauge G in advance.

The strain gauge sensor device 10 configured as described above can detect the strain state of the test object by detecting the detection values of the strain gauges G1 to Gn while the base substrate 44 on which the sensor sheets 20 are stacked is attached on the surface of the test object. Further, by calculating the detection values of the strain gauges G1 to Gn in a state where the sensor sheet 20 is attached to a curved surface, or in a state where the base substrate 44 on which the sensor sheet 20 is stacked is wrapped around a circumferential surface of a cylindrical body, the curved shape or circumferential shape of the surface can be detected or quantified.

According to the strain gauge sensor device 10 of this embodiment, open-close switches are provided between the power supply line and the strain gauges, and between the ground line and the strain gauges, and these open-close switches are selectively opened and closed. With this configuration, it is possible to sequentially drive (scan drive) the power supply of a plurality of strain gauges. Thus, current can be supplied only to the strain gauges G to be scanned, thereby making it possible to reduce the sensor power consumption during strain detection as compared to the case where the power supply to all the strain gauges G1 to Gn is on at all times.

According to the strain gauge sensor device 10 of the present embodiment, switches are provided between the signal lines and the strain gauges, and these switches are selectively opened and closed. With this configuration, it is possible to sequentially drive (scan drive) the signal line for each strain gauge. When the signal lines are sequentially driven, no charging or discharging of wiring parasitic capacitance occurs, and therefore the response speed of the strain gauge sensor can be increased.

Furthermore, according to the strain gauge sensor device 10 of the present embodiment, open-close switches are provided between the strain gauges G and the wiring lines, and each strain gauge G and the respective wiring line can be selectively connected. With this configuration, common power lines, common ground lines, and common signal lines can be used for the plurality of strain gauges G1 to Gn. Consequently, the number of wiring lines and the area occupied by the wiring lines are reduced, enabling the miniaturization of the sensor.

As described above, according to this embodiment, it is possible to provide a strain gauge sensor device that can reduce power consumption and achieve miniaturization.

Next, strain gauge sensor devices according to other embodiments will be described. In the following descriptions of the other embodiments, the same parts used in the first embodiment are denoted by the same reference numerals as those used in the first embodiment, and detailed descriptions may be omitted or simplified.

### Second Embodiment

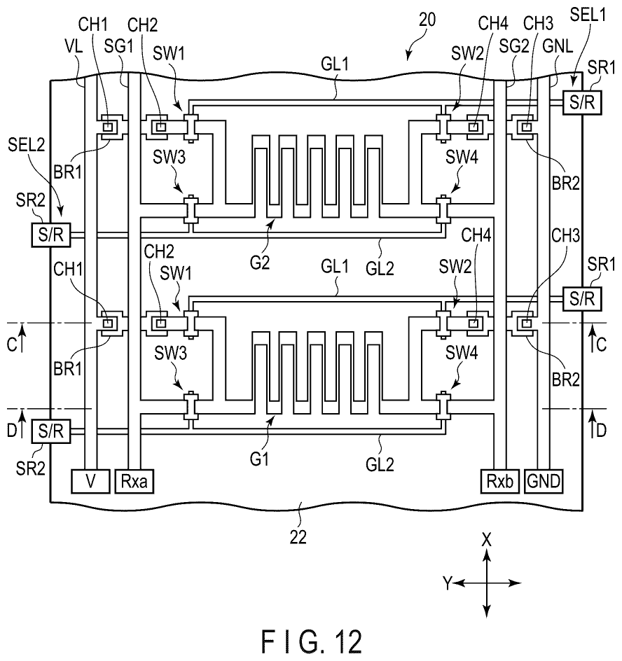

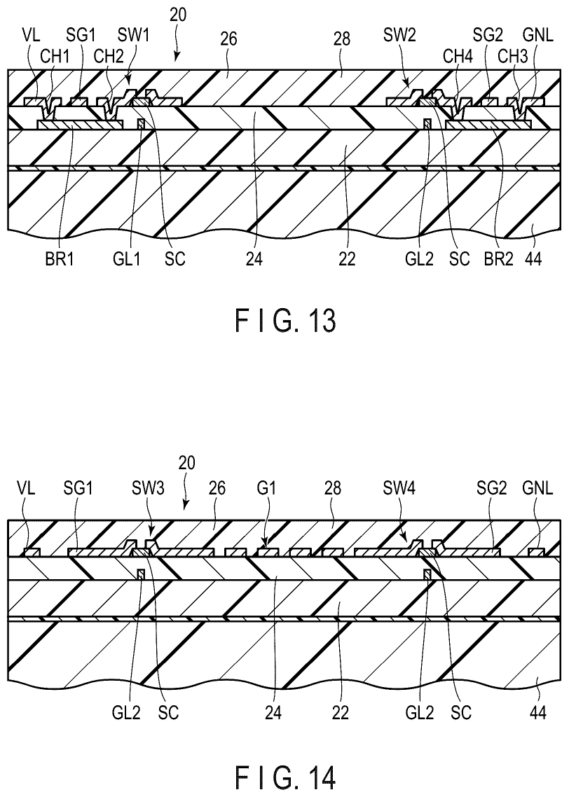

FIG. 12 is a plan view showing the wiring structure of a sensor sheet in a strain gauge sensor device according to the second embodiment, FIG. 13 is a cross-sectional view of the sensor sheet taken along the line C-C in FIG. 12, and FIG. 14 is a cross-sectional view of the sensor sheet taken along the line D-D in FIG. 12.

The second embodiment is different from the first embodiment described above in that the wiring structure of the sensor sheet 20 is configured as a two-layer structure comprising a so-called gate line layer and a signal line layer.

In more detail, as shown in FIGS. 12, 13, and 14, in the sensor sheet 20, gate lines GL1 and GL2 and bridge wiring lines BR1 and BR2 of the same layer are provided on the surface of the sheet substrate 22. The bridge wiring lines BR1 and BR2 each extend in the width direction Y for a predetermined length and are provided at positions facing the first signal line SG1 and the second signal line SG2, respectively.

Overlaid on the gate lines GL1, GL2, and the bridge wiring lines BR1 and BR2, an interlayer film (gate insulating film) 24 is stacked on the surface of the sheet substrate 22. On the interlayer film 24, a semiconductor layer SC and a conductive layer are formed. The conductive layer forms the wiring pattern of the strain gauges G1 to Gn, the power supply line VL, the ground line GND, the first signal line SG1, and the second signal line SG2. Each semiconductor layer SC faces the gate formed of the gate lines GL1 and GL2, while interposing the interlayer film 24 therebetween. Overlaid on the conductive layer, a protective film 28 is stacked on the interlayer film 24.

As shown in FIGS. 12 and 13, the branch wiring line that branches from the power supply line VL and connects to one end of the strain gauge G is cut by a predetermined length at a portion where it crosses the first signal line SG1, and both ends of the cut portion respectively face the first signal line SG1 with a gap from the respective end. Both ends of the cut portion are each connected to the bridge wiring line BR1 of the lower layer via a respective one of the contact holes CH1 and CH2. Furthermore, a part of the branch wiring line is located to overlap the semiconductor layer SC and constitutes the source electrode and the drain electrode. With this configuration, the gate, the semiconductor layer SC, the source electrode, and the drain electrode form a thin-film transistor (TFT), that is, the first open/close switch SW1. Thus, the power supply line VL is connected to one end of the strain gauge G via the branch wiring line, the bridge wiring line BR1, and the first open/close switch SW1.

The branch wiring line that branches from the ground line GNL and connects to the other end of the strain gauge G is cut by a predetermined length at the portion where it crosses the second signal line SG2, and both ends of the cut portion respectively face the second signal line SG2 with a gap from the respective end. Both ends of the cut portion are each connected to the bridge wiring line BR2 of the lower layer via a respective one of contact holes CH3 and CH4. Further, a part of the branch wiring line is located to overlap the semiconductor layer SC and constitutes the source electrode and the drain electrode. Thus, the gate, the semiconductor layer SC, the source electrode, and the drain electrode constitute a thin-film transistor (TFT), that is, the second open/close switch SW2. With this configuration, the ground line GNL is connected to the other end of the strain gauge G via the branch wiring line, the bridge wiring line BR2, and the second open/close switch SW2.

As shown in FIGS. 13 and 14, the branch wiring line that branches from the first signal line SG1 and connects to one end of each of the strain gauges G is cut in a middle, and the end portion on the cut side of each branch wiring line is located to overlap the semiconductor layer SC, thus forming the source electrode or the drain electrode, respectively. With this configuration, the gate, the semiconductor layer SC, the source electrode, and the drain electrode form a thin-film transistor (TFT), that is, the third open/close switch SW3. The first signal line SG1 is connected to one end of the strain gauge G via the branch wiring line and the third open/close switch SW3.

Similarly, the branch wiring line that branches from the second signal line SG2 and connects to the other end of each of the strain gauges G is cut in a middle, and the end portion on the cut side of the branch wiring line is located to overlap the semiconductor layer SC, thus forming the source electrode or drain electrode, respectively. With this operation, the gate, the semiconductor layer SC, the source electrode, and the drain electrode constitute a thin-film transistor (TFT), that is, the fourth open/close switch SW4. The second signal line SG2 is connected to the other end of the strain gauge G via the branch wiring line and the fourth open/close switch SW4.

According to the second embodiment configured as described above, the wiring pattern of the sensor sheet 20 is formed into a two-layer structure, and with this configuration, it is possible to further reduce the thickness of the sensor sheet 20. Further, in the strain gauge sensor device according to the second embodiment as well, advantageous effects similar to those of the strain gauge sensor device according to the first embodiment described above can be obtained.

### Third Embodiment

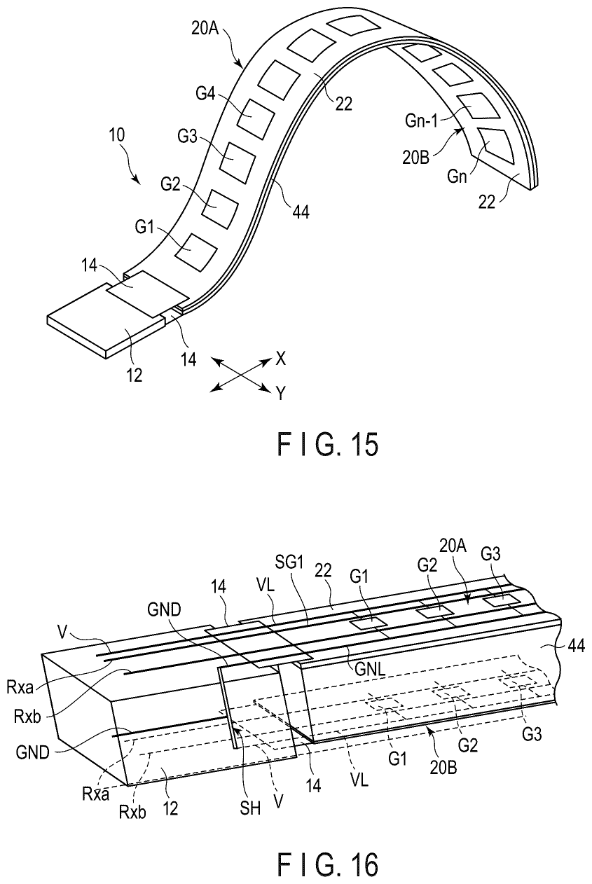

FIG. 15 is a perspective view showing a strain gauge sensor device according to the third embodiment, and FIG. 16 is a perspective view schematically showing the proximal end portion of the sensor sheet and the intermediate substrate in the strain gauge sensor device.

As shown in the figure, the strain gauge sensor device 10 according to the second embodiment constitutes a double-sided strain gauge sensor. The strain gauge sensor device 10 comprises a slender strip-shaped flexible base substrate 44, a first sensor sheet 20A attached to the first main surface (front surface) of the base substrate 44, a second sensor sheet 20B attached to the second main surface (rear surface) of the base substrate 44, an intermediate board (drive circuit board) 12 connected to the first sensor sheet 20A and the second sensor sheet 20B via the flexible printed circuit board (FPC) 14. In one example, the base substrate 44 is formed from a resin such as polyethylene terephthalate (PET) or polyimide to have a thickness of approximately 0.3 to 0.5 mm.

Each of the first sensor sheet 20A and the second sensor sheet 20B includes a slender strip-shaped flexible sheet substrate 22 and a conductor pattern provided on one surface side of the sheet substrate 22. The conductor pattern includes a plurality of strain gauges G1 to Gn. These strain gauges G1 to Gn are aligned in the longitudinal direction X at predetermined intervals from one end to the other end of the sheet substrate 22 in the longitudinal direction X. The strain gauges G1 to Gn of the first sensor sheet 20A are disposed to face the strain gauges G1 to Gn of the second sensor sheet 20B, respectively, while each interposing the base substrate 44 therebetween.

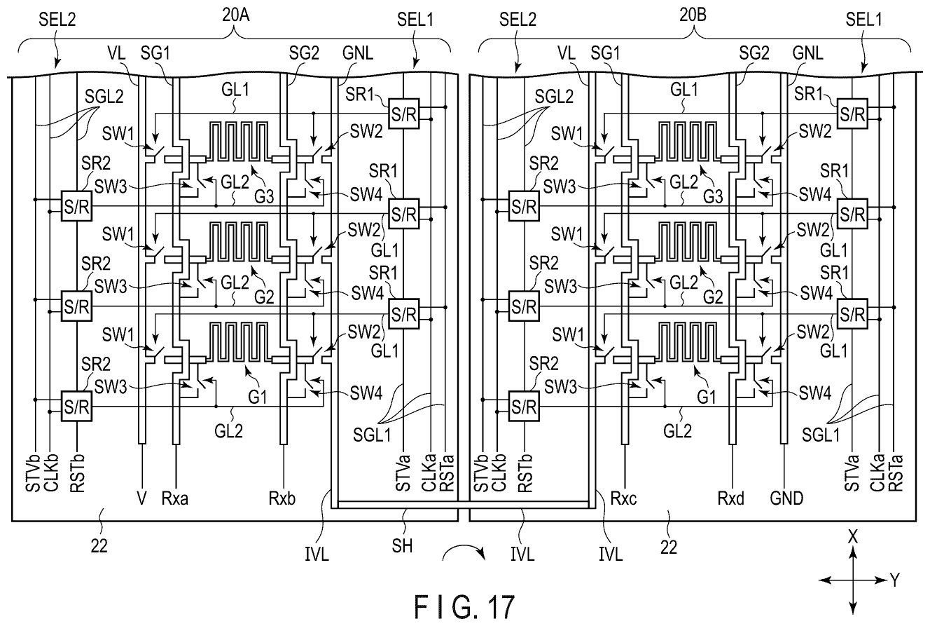

FIG. 17 is a plan view schematically showing the strain gauges and wiring patterns of the first sensor sheet 20A and the second sensor sheet 20B. As shown in the figure, each of the first sensor sheet 20A and the second sensor sheet 20B is configured in a manner similar to that of the sensor sheet 20 in the first embodiment described above. That is, the first sensor sheet 20A includes a flexible strip-shaped sheet substrate 22 and a conductor pattern provided on one side of the sheet substrate 22. The conductor pattern of the first sensor sheet 20A includes a plurality of strain gauges G1 to Gn. These strain gauges G1 to Gn are aligned at intervals in the longitudinal direction X of the first sensor sheet 20A. Each of the strain gauges G1 to Gn extends in a bellows manner in the width direction Y and has one end and the other end in the width direction Y. Each of the strain gauges G1 to Gn generates a resistance change in response to strain.

The conductor pattern includes a power line VL, a ground line GN, and two signal lines SG1 and SG2, each extending in the longitudinal direction X along the row of the strain gauges G1 to Gn. The first signal line SG1 and the power supply line VL are located on one end side of the strain gauges G1 to Gn, and further, the power supply line VL is located to be spaced apart from the first signal line SG1 on an outer side thereof in the width direction Y. The second signal line SG2 and the ground line GN are located on an opposite end side of the strain gauges G1 to Gn, and further, the ground line GN is located to be spaced apart from the second signal line SG2 on an outer side thereof in the width direction Y.

One end of each of the strain gauges G1 to Gn is connected to the power supply line VL via the first open/close switch SW1. The other end of each of the strain gauges G1 to Gn is connected to the ground line GNL via the second open/close switches SW2. Further, one end of each of the strain gauges G1 to Gn is connected to the first signal line SG1 via the third open/close switches SW3. The other end of each of the strain gauges G1 to Gn is connected to the second signal line SG2 via the fourth open/close switch SW4.

The first to fourth open/close switches SW1 to SW4 are each configured by a switching element, for example, a thin film transistor (TFT).

The first sensor sheet 20A includes a first selector SEL1 for switching the first open/close switch SW1 and second open/close switch SW2 of each of the strain gauges G1 to Gn, and a second selector SEL2 for switching the third open/close switch SW3 and fourth open/close switch SW4 of each of the strain gauges G1 to Gn. The first selector SEL1 includes a plurality of shift registers (S/R) SR1 aligned in the longitudinal direction X on a side of the ground line GNL and corresponding to the strain gauges G1 to Gn, respectively, three signal lines SGL1 for inputting signals (RSTa, CLKa, STVa) to these shift registers SR1, and a gate line GL1 for inputting the output signal of each of the shift registers SR1 to the corresponding first open/close switch SW1 and second open/close switch SW2.

The second selector SEL2 includes a plurality of shift registers (S/R) SR2 arranged in the longitudinal direction X on a side of the power supply line VL and corresponding to the strain gauges G1 to Gn, respectively, three signal lines SGL2 for inputting signals (RSTb, CLKb, STVb) to these shift registers SR2, and a gate line GL2 for inputting the output signal of each of the shift registers SR2 to the corresponding third open/close switches SW3 and fourth open/close switches SW4.

The second sensor sheet 20B is configured in a fashion similar to that of the first sensor sheet 20A. The same parts are denoted by the same reference numerals and their detailed descriptions will be omitted.

The first sensor sheet 20A and the second sensor sheet 20B, configured as described above, are attached to the base substrate 44 by adhering the sheet substrate 22 side to the front and rear surfaces of the base substrate 44, and are disposed to face each other while interposing the base substrate 44 therebetween.

Here, it is preferable that the strain gauges G1 to Gn of the first sensor sheet 20A and the strain gauges G1 to Gn of the second sensor sheet 20B respectively overlap each other at least partially when viewed in plan view. Or, the strain gauges G1 to Gn of the sensor sheets 20A and 20B should preferably be placed to overlap each other while allowing some displacement in the longitudinal direction X but without being displaced in the width direction Y. Or, the strain gauges G1 to Gn of the sensor sheets 20A and 20B should preferably be placed to overlap each other without being displaced in the longitudinal direction X as well as the width direction Y.

As shown in FIG. 16, the ground line GNL of the first sensor sheet 20A extends through the FPC 14 to the intermediate substrate 12. The power line VL of the second sensor sheet 20B extends through the FPC 14 to the intermediate substrate 12. The ground line GNL and the power supply line VL are electrically connected to each other at the position of the intermediate substrate 12 via a connection line formed on the intermediate substrate 12, for example, a plated through hole SH. Thus, the strain gauges G1 to Gn of the first sensor sheet 20A are connected in series to the corresponding strain gauges G1 to Gn of the second sensor sheet 20B. Note that in this embodiment, the ground line GNL of the first sensor sheet 20A functions as a power supply line supplying voltage to the power supply line VL of the second sensor sheet 20B, and therefore the ground line GNL may be referred to as an intermediate power supply line of the first sensor sheet 20A, hereinafter. Or, the ground line GNL of the first sensor sheet 20A, the power supply line VL of the second sensor sheet 20B, and the connecting line connecting these may collectively be referred to as the intermediate power supply line IVL. Further, for the connecting line, not only a plated through hole SH, but also a wiring pattern on an intermediate substrate or the like may as well be used.

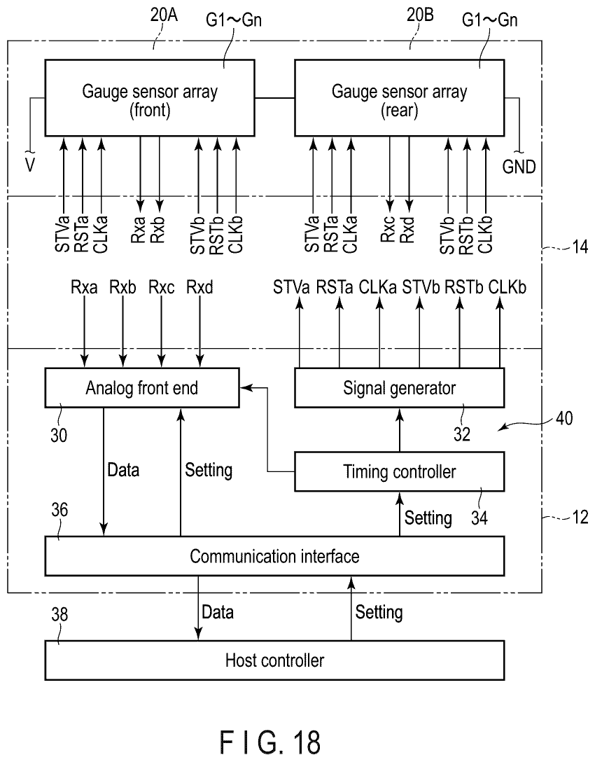

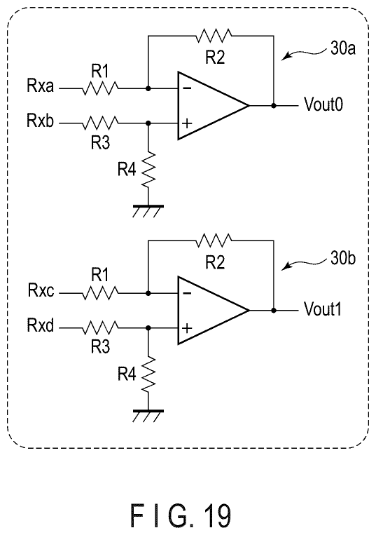

Next, the drive circuit (controller) that drives the first sensor sheet 20A and the second sensor sheet 20B configured as described above will be explained. FIG. 18 is a block diagram schematically showing the drive circuit (controller) of the strain gauge sensor device 10, and FIG. 19 is a circuit diagram of the differential detection circuit in the analog front end.

As shown in FIG. 18, the drive circuit 40 provided on the intermediate board (control circuit board) 12 includes an analog front end (AFE: signal adjustment circuit) 30, a signal generator 32, a timing controller 34, a communication interface 36, and the like.

The communication interface 36 is connected to an external host controller 38 wirelessly or via wire, receives drive signals (setting) from the host controller 38, and outputs detection data (Data) to the host controller 38.

The timing controller 34 outputs drive signals to the signal generator 32 and the analog front end 30 in response to the drive signals (setting).

The signal generator 32 generates a clock signal CLKa, a reset signal RSTa, and a data signal STVa in response to the drive signals from the timing controller 34, and inputs each of the signals CLKa, RSTa, and STVa to the first selector SEL1 of the first sensor sheet 20A and the first selector SEL1 of the second sensor sheet 20B. Further, the signal generator 32 generates a clock signal CLKb, a reset signal RSTb, and a data signal STVb, and inputs each of the signals CLKb, RSTb, and STVb to the second selector SEL2 of the first sensor sheet 20A and the second selector SEL2 of the second sensor sheet 20B. That is, the same signals are input to the corresponding signal lines of these sensor sheets 20A and 20B.

The analog front end 30 includes a readout circuit, an A/D converter, a digital filter, and the like. As shown in FIG. 19, according to this embodiment, the analog front end 30 includes a differential detection circuit (subtraction circuit) 30a for processing the detection signals from the first sensor sheet 20A, and a differential detection circuit (subtraction circuit) 30b for processing the detection signals from the second sensor sheet 20B. The analog front end 30 adjusts (amplifies, AD-converts, and filters) the detection signals RXa and RXb sent from each of the strain gauges G1 to Gn in response to the drive signal, and outputs them to the communication interface 36. At this time, the voltage drop value of each of the strain gauges G is required for calculating the curvature radius, and therefore the difference between the detection values Rxa and Rxb of each of the strain gauges G1 to G n, and the difference between the detection values Rx c and Rx d of each of the strain gauges G1 to G n, are taken by the difference detection circuits 30a and 30b and output as signals.

The host controller 38 reads the output signal (data) sent from the communication interface 36, performs data shaping, arithmetic processing including curved surface calculation, and the like, and calculates out the strain, the shape of the curved surface, and the like of the test object detected by the sensor sheets 20A and 20B.

Next, the operation mode of the strain gauge sensor device 10 will be described.

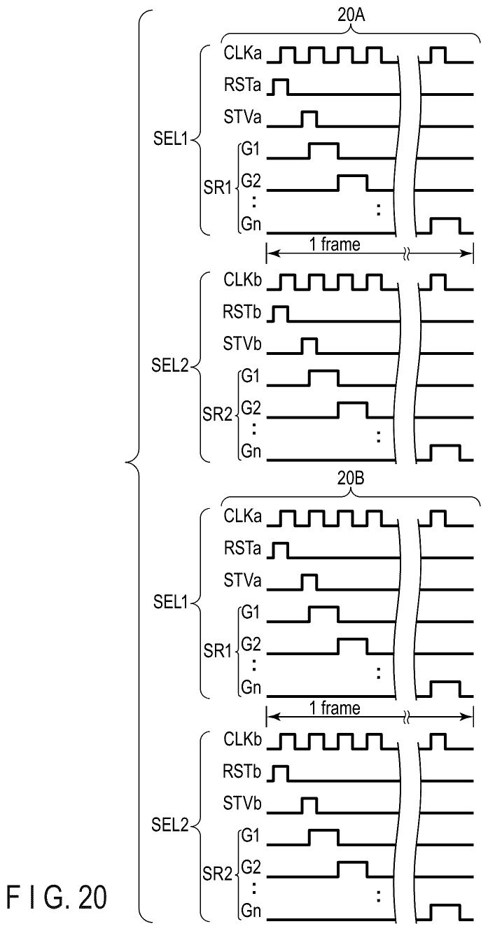

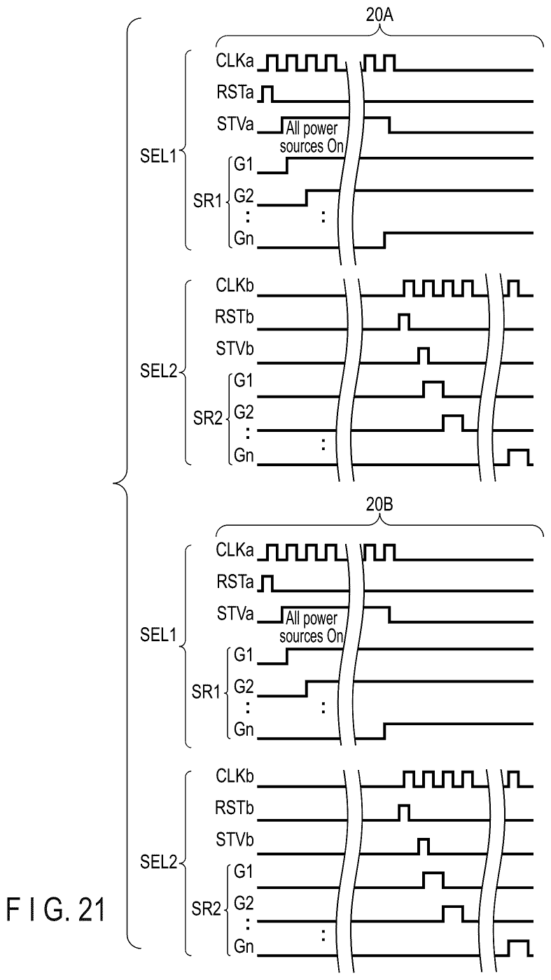

FIG. 20 is a timing chart showing the output signal when operating in the sleep mode (first operation mode), and FIG. 21 is a timing chart showing the output signal when operating in the active mode (second operation mode).

As shown in FIG. 20, in the sleep mode, the power and signal lines are subjected to scan drive to sequentially supply potentials to the strain gauges G1 to Gn and sequentially read the detection values of the strain gauges G1 to Gn. In detail, as shown in FIG. 20, in response to instructions from the host controller 38, the drive circuit 40 inputs the clock signal CLKa to all the shift registers SR1 of the first sensor sheet 20A and all the shift registers SR1 of the second sensor sheet 20B. Further, the drive circuit 40 inputs the reset signal RSTa to all the shift registers SR1 of the first sensor sheet 20A and all the shift registers SR1 of the second sensor sheet 20B in synchronization with the clock signal CLKa. With this operation, all the shift registers SR1 of the first selectors SEL1 of the first sensor sheet 20A and the second sensor sheet 20B are reset. Thereafter, the drive circuit 40 inputs the data signal STVa, which is the start pulse for the shift registers, to the first-stage shift register SR1 (shift register corresponding to the strain gauge G1) of the first sensor sheet 20A, and further inputs the data signal STVa to the first-stage shift register SR1 (shift register corresponding to the strain gauge G1) of the first sensor sheet 20B. With this operation, the first-stage shift registers SR1 of the first sensor sheet 20A and the second sensor sheet 20B output an on signal to the first open/close switch SW1 and the second open/close switch SW2 for a certain period of time, thus turning on (close) the first open/close switch SW1 and the second open/close switch SW2 for a certain period of time. After a certain period of time has elapsed, the on signal is turned off, and the first open/close switch SW1 and the second open/close switch SW2 are switched to off (open). While the first open/close switch SW1 and the second open/close switch SW2 are on, the strain gauge G1 of the first sensor sheet 20A is connected to the power line VL and the ground line GN (intermediate power line IVL), and the strain gauge G1 of the second sensor sheet 20B is connected to the power line VL (intermediate power line IVL) and the ground line GN. That is, during the certain period of time, the drive circuit 40, the strain gauge G1 of the first sensor sheet 20A, and the strain gauge G1 of the second sensor sheet 20B are connected in series via the power line VL and the intermediate power line IVL of the first sensor sheet 20A and the ground line GNL of the second sensor sheet 20B, and the power supply voltage is applied to the strain gauges G1 of both sensor sheets 20A and 20B from the drive circuit 40.

After that, in the first sensor sheet 20A and the second sensor sheet 20B, an input signal is input from the first-stage shift register SR1 to the second-stage shift register SR1 (sift register corresponding to the strain gauge G2). The input signal corresponds to the data signal STVa input to the first-stage shift register SR1, and thereby, the second-stage shift register SR1 outputs an on signal to the first open/close switch SW1 and the second open/close switch SW2 for a certain period of time, thus turning on (close) the first open/close switch SW1 and the second open/close switch SW2 for a certain period of time. While the first open/close switch SW1 and the second open/close switch SW2 are on, the drive circuit 40, the strain gauges G2 of the first sensor sheet 20A and the strain gauges G2 of the second sensor sheet 20B are connected in series via the power line VL and the intermediate power line IVL of the first sensor sheet 20A and the ground line GNL of the second sensor sheet 20B, and a power supply voltage is applied to the strain gauges G2 of both sensor sheets 20A and 20B from the drive circuit 40.

From this point on, in a manner similar to the above, input signals as those described above are sequentially input to the third to nth-stage shift registers SR1 of the first sensor sheet 20A and the second sensor sheet 20B over one frame, and the first open/close switch SW1 and the second open/close switch SW2 are sequentially turned on. While the on period, the strain gauges G3 to Gn of both sensor sheets 20A and 20B are connected in series, and the power supply voltage is applied sequentially to these strain gauges G3 to Gn.

The drive circuit 40 inputs the clock signal CLKb, the reset signal RSTb synchronized with the clock signal, and the data signal STVb to the second selector SEL2 of the first sensor sheet 20A and to the second selector SEL2 of the second sensor sheet 20B in synchronization with the scanning drive of the power supply line. More specifically, the drive circuit 40 inputs the clock signal CLKb to all the shift registers SR2 of the first sensor sheet 20A and all the shift registers SR2 of the second sensor sheet 20B. The clock signal CLKb is substantially the same signal as the clock signal CLKa. Further, the drive circuit 40 inputs a reset signal RSTb to all the shift registers SR2 of the first sensor sheet 20A and all the shift registers SR2 of the second sensor sheet 20B in synchronization with the clock signal CLKb. The reset signal RSTb is synchronized with the reset signal RSTa and is supplied to all the shift registers SR2 at the same timing as that of the reset signal RSTa. With this operation, all the shift registers SR2 are reset. Subsequently, the drive circuit 40 inputs a data signal STVb, which is the start pulse for the shift registers, to the first-stage shift registers SR2 (shift registers corresponding to strain gauges G1) of the first sensor sheet 20A and the second sensor sheet 20B. The data signal STVb is synchronized with the data signal STVa and is supplied to the first-stage shift registers SR2 at the same timing as that of the data signal STVa. With this operation, the first-stage shift registers SR2 of the first sensor sheet 20A and the second sensor sheet 20B output an on signal to the third open/close switch SW3 and the fourth open/close switch SW4 of the strain gauge G1 at the same timing as that of the first-stage shift registers SR1 for a certain period of time, thereby turning on (close) the third open/close switch SW3 and the fourth open/close switch SW4 for a certain period of time. After the certain period of time has elapsed, the on signal is turned off, and the third open/close switch SW3 and the fourth open/close switch SW4 are switched to off (open). While the third open/close switch SW3 and the fourth open/close switch SW4 are on, one end and the other end of the strain gauge G1 of the first sensor sheet 20A are connected to the first signal line SG1 and the second signal line SG2, respectively, and the detection signal (voltage value) RXa from one end of the strain gauge G1 and the detection signal (voltage value) RXb from the other end are output to the first and second signal lines SG1 and SG2. At the same time, one end and the other end of the strain gauge G1 of the second sensor sheet 20B are connected to the first signal line SG1 and the second signal line SG2, respectively, and the detection signal (voltage value) RXc of the one end of the strain gauge G1 and the detection signal (voltage value) RXd of the other end are output to the first and second signal lines SG1 and SG2, respectively. The detection signals RXa, RXb, RXc, and RXd are sent to the analog front end 30 of the drive circuit 40 via the first and second signal lines SG1 and SG2, respectively.

After that, in the first sensor sheet 20A and the second sensor sheet 20B, an input signal is input to the second-stage shift register SR2 (shift registers corresponding to the strain gauge G2) from the first-stage shift register SR2. This input signal corresponds to the data signal STVb input to the first-stage shift register SR2, and thereby, in the first sensor sheet 20A and the second sensor sheet 20B, the second-stage shift register SR2 outputs an on signal to the third open/close switch SW3 and the fourth open/close switch SW4 at the same timing as that of the second stage of the shift register SR1 for a certain period of time, thereby turning on (close) the third open/close switch SW3 and the fourth open/close switch SW4 for a certain period of time. While the third open/close switch SW3 and the fourth open/close switch SW4 are on, one end and the other end of the strain gauge G2 of the first sensor sheet 20 are connected to the first signal line SG1 and the second signal line SG2, respectively and the detection signal (voltage value) RXa from one end of the strain gauge G2 and the detection signal (voltage value) RXb from the other end of the strain gauge G2 are output to the first and second signal lines SG1 and SG2, respectively. At the same time, one end and the other end of the strain gauge G2 of the second sensor sheet 20B are connected to the first signal line SG1 and the second signal line SG2, respectively, and the detection signal (voltage value) RXc of the one end of the strain gauge G2 and the detection signal (voltage value) RXd of the other end are output to the first and second signal lines SG1 and SG2, respectively. The detection signals RXa, RXb, RXc, and RXd are sent to the analog front end 30 of the drive circuit 40 via the first and second signal lines SG1 and SG2, respectively.

From this point on, in a manner similar to the above, input signals such as those described above are sequentially input to the third to nth-stage shift registers SR2 of the first sensor sheet 20A and the second sensor sheet 20B over one frame. With this operation, the third open/close switch SW3 and the fourth open/close switch SW4 of the shift register SR2 are sequentially switched to the on state in accordance with the timing in which the first open/close switch SW1 and the second open/close switch SW2 of the shift register SR1 are sequentially turned on. Thus, the detection signals RXa and RXb from the first strain gauge G3 to Gn of the first sensor sheet 20A are sequentially output to the first and second signal lines SG1 and SG2, and the detection signals RXc and RXd from the second strain gauge G3 to Gn of the second sensor sheet 20B are sequentially output to the first and second signal lines SG1 and SG2.

The detection signals RXa, RXb, RXc, and RXd are sequentially sent to the analog front end 30, where they are subjected to adjustment and differential detection. All the detection signals RXa, RXb, RXc, and RXd subjected to the adjustment and differential detection are collectively sent to the communication interface 36, and further sent to the host controller 38 via the communication interface 36.

As described above, the first sensor sheet 20A and the second sensor sheet 20B are scanned and driven in synchronization with each other, and the same location is subjected to strain detection at the same time by two strain gauges G1 to Gn positioned to face each other detect strain.

In the sleep mode described above, current is supplied only to the strain gauges G to be scanned, and therefore the sensor power consumption during strain detection can be decreased to a level lower than that of the case where the power supply of all the strain gauges G1 to Gn is on at all times.

On the other hand, as shown in FIG. 21, in the active mode (second operation mode), after supplying potential to all the strain gauges G1 to Gn of the first sensor sheet 20A and the second sensor sheet 20B, only the signal lines SG1 and SG2 are scan-driven at the same time in both the sensor sheets 20A and 20B, thereby sequentially reading the detection values of the strain gauges G1 to Gn in these sensor sheets 20A and 20B. In detail, as shown in FIG. 21, in response to instructions from the host controller 38, the drive circuit 40 outputs a clock signal CLKa to each of the shift registers SR1 of the first sensor sheet 20A and each of the shift registers SR1 of the second sensor sheet 20B. Further, the drive circuit 40 outputs a reset signal RSTa synchronized with the clock signal CLKa to all the shift registers SR1 of the first sensor sheet 20A and all the shift registers SR1 of the second sensor sheet 20B. With this operation, all the shift registers SR1 of the first selector SEL1 of the first sensor sheet 20A and the second sensor sheet 20B are reset. Thereafter, the drive circuit 40 inputs a data signal STVa, which is the start pulse for the shift registers, to the first-stage shift register SR1 (shift register corresponding to the strain gauge G1) of the first sensor sheet 20A, and simultaneously inputs a similar data signal STVa to the first-stage shift register SR1 (shift register corresponding to the strain gauge G1) of the second sensor sheet 20B. With the data signal STVa, the first-stage shift registers SR1 of the sensor sheets 20A and 20B are maintained at the on level during the frame period (until the next reset signal is input). As the input signals corresponding to the data signal STVa are sequentially supplied to the next-stage shift registers SR1, in the first sensor sheet 20A and the second sensor sheet 20B, each of the shift registers SR1 from the first-stage shift register SR1 to the final stage shift register SR1 sequentially outputs an on signal to the first open/close switch SW1 and the second open/close switch SW2. Note that the on signal is maintained until a reset signal is input in the next frame.

Thus, during the frame period, the strain gauges G1 to Gn of the first sensor sheet 20A and the strain gauges G1 to Gn of the second sensor sheet 20B are sequentially connected in parallel. More specifically, first, the strain gauge G1 of the first sensor sheet 20A and the strain gauge G1 of the second sensor sheet 20B are connected in series via the intermediate power supply line IVL. Next, the strain gauges G1 and G2 of the first sensor sheet 20A and the strain gauges G1 and G2 of the second sensor sheet 20B are connected in parallel via the intermediate power supply line IVL. From this on, the number of strain gauges connected in parallel increases as time progresses until the end of the frame period. Note that the strain gauges G1 to Gn of the first sensor sheet 20A are connected to the drive circuit 40 via the power line VL, and the strain gauges G1 to Gn of the second sensor sheet 20B are connected to the drive circuit 40 via the ground line GNL. Thus, current flows to all the strain gauges G1 to Gn.

After turning on all the first open/close switches SW1 and second open/close switches SW2, the drive circuit 40 inputs the clock signal CLKb to all the shift registers SR2 of the first sensor sheet 20A and all the shift registers SR2 of the second sensor sheet 20B. Further, the drive circuit 40 inputs a reset signal RSTb synchronized with the clock signal CLKb to all the shift registers SR2 of the first sensor sheet 20A and all the shift registers SR2 of the second sensor sheet 20B. Thereafter, the drive circuit 40 inputs the data signal STVb, which is the start pulse for the shift registers, to the first-stage shift registers SR2 of the first sensor sheet 20A and simultaneously to the first-stage shift registers SR2 of the second sensor sheet 20B. With this operation, the shift registers SR2 of both the sensor sheets 20A and 20B sequentially outputs an on signal to the third open/close switch SW3 and the fourth open/close switch SW4, thereby switching the third open/close switch SW3 and the fourth open/close switch SW4 to the on (close) state for a predetermined time. Thus, in the first sensor sheet 20A, the strain gauges G1 to Gn are sequentially connected to the first and second signal lines SG1 and SG2, and the detection values (detection signals) RXa and RXb of the respective end portions of the strain gauges G are output to the first and second signal lines SG1 and SG2 at regular intervals.

Similarly, in the second sensor sheet 20B, the strain gauges G1 to Gn are sequentially connected to the first and second signal lines SG1 and SG2, and the detection values (detection signals) RXc and RXd of the respective end portion of the strain gauge G are output to the first and second signal lines SG1 and SG2 at regular intervals. That is, the first sensor sheet 20A and the second sensor sheet 20B are provided on front and rear sides of the base substrate 44, respectively, but the detection values of the strain gauges G1 to Gn, which are arranged to face each other, are output to the drive circuit 40 at the same time. More specifically, when the detection values RXa and RXb are detected by the strain gauge G1 of the first sensor sheet 20A, simultaneously, the detection values RXc and RXd are detected by the strain gauge G1 of the second sensor sheet 20B, and this continues from the strain gauges G2 on.

The detection signals RXa, RXb, RXc, and RXd are sent to the analog front end 30 of the drive circuit 40 via the first and second signal lines SG1 and SG2. The detection signals RXa, RXb, RXc, and RXd are adjusted by the analog front end 30, and then sent to the host controller 38 via the communication interface 36.

As described above, by driving the first sensor sheet 20A and the second sensor sheet 20B in synchronization with each other, the same location is subjected to detect strain simultaneously by two located to face each other of the gauges G1 to Gn.

In the active mode described above, all the first open/close switches SW1 and second open/close switches SW2 are maintained in the on state, and therefore the variation in parasitic capacitance in the power line VL and ground line GNL is smaller as compared to that in the sleep mode, and the response speed of the strain gauge sensor can be increased faster than that in the sleep mode.

Next, a method for calculating a curved surface configuration, in one example, a curvature radius using a double-sided strain gauge sensor device, will be explained.

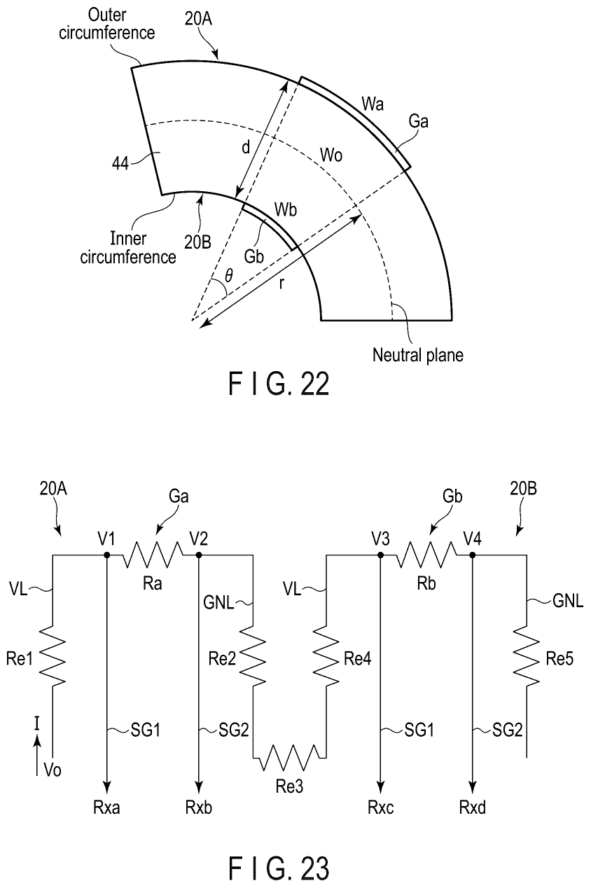

FIG. 22 is a schematic diagram showing a part of a strain gauge sensor device installed on the circumferential surface of a test object. As shown in the figure, when installed on the circumferential surface, the neutral plane of the base substrate 44 is curved by the same curvature radius r as that of the circumferential surface. Here, the term “neutral plane” is the surface where no elongation or contraction occurs between before and after the bending of the strain gauge sensor (that is, the strain remains zero after bending). In this embodiment, since the same sensor sheet is provided on both surfaces of the base substrate 44, the neutral plane may be set at a position corresponding to a half of the thickness (×½) of the base substrate 44. The strain gauges Ga of the first sensor sheet 20A located on the outer circumferential side and the strain gauges Gb of the second sensor sheet 20B located on the inner circumferential side face each other in the radial direction.

In the equations shown in FIG. 22 and below, W0 represents the initial width of the strain gauge, Wa represents the width of the strain gauge on the outer circumferential side, Wb represents the width of the strain gauge on the inner circumferential side, ΔW represents the change in width of the strain gauge, d represents the thickness of the base substrate, θ represents the opening angle of the strain gauge, r represents the curvature radius of the neutral plane, k represents the gauge factor, R0 represents the reference resistance of the strain gauge, and ΔR represents the change in resistance of the strain gauge.

When the width of the strain gauge G on the neutral plane of the base substrate 44 is set as the initial width W0 of the strain gauge, W0=rθ can be established. The strain gauge Ga on the outer circumferential side deforms into a state where it is elongated in the width direction due to bending, and its gauge width Wa is expressed by:

$${W}_{a} = ( r + \frac{d}{2} ) θ = {W}_{0} + Δ W$$

The strain gauge Gb on the inner circumferential side deforms into a state where it is contracted in the width direction by bending, and its gauge width Wb is given by:

$${W}_{b} = ( r - \frac{d}{2} ) θ = {W}_{0} - Δ W$$

Note that the change in width ΔW is given by ΔW=dθ/2, and the curvature radius r of the neutral plane (corresponding to the circumferential surface of the test object) is given by:

$$r = \frac{{W}_{0}}{θ} = \frac{d}{2} \frac{{W}_{0}}{Δ W} = \frac{k d}{2} \frac{{R}_{0}}{Δ R} \qquad ( 3 )$$

FIG. 23 is a schematic diagram showing the equivalent circuit of the first sensor sheet 20A and the second sensor sheet 20B.

As shown in the figure, according to this embodiment, the ground line GNL of the first sensor sheet 20A is connected to the power supply line VL of the second sensor sheet 20B via a connection line, and with these lines, an intermediate power supply line IVL is formed (see FIG. 17). With this configuration, the strain gauges Ga on the outer circumferential side and the strain gauges Gb on the inner circumferential side are connected in series. During strain detection, voltage drops are measured at one end and the other end of each of the strain gauges Ga and Gb.

Here, let us set the followings: the initial resistance values of each of the strain gauges Ga and Gb before deformation is represented by R0, the resistance value of the outer circumferential strain gauge Ga after deformation is represented by Ra, the resistance value of the inner circumferential strain gauge Gb after deformation is represented by Rb, the voltage values at one end and the other end of the strain gauge Ga on the outer circumferential side are represented by V1 and V2, respectively, the voltage values at one end and the other end of the strain gauge Gb on the inner circumferential side are represented by V3 and V4, the resistance change of the strain gauge is represented by ΔR, and the current flowing through each of the strain gauges Ga and Gb is represented by I. Then, the voltage drop V12 between one end and the other end of the strain gauge Ga, and the voltage drop V34 between one end and the other end of the strain gauge Gb are expressed by:

$$\begin{matrix}{V}_{12} = {V}_{1} - {V}_{2} = {R}_{a} I \\ {V}_{34} = {V}_{3} - {V}_{4} = {R}_{b} I\end{matrix}$$

When the above equation is divided by the equation below, the following relationship is yielded:

$$\frac{{V}_{12}}{{V}_{34}} = \frac{{R}_{a}}{{R}_{b}}$$

When this equation is expressed using the change in strain gauge resistance, the following equation is obtained.

$$\frac{{V}_{12}}{{V}_{34}} = \frac{{R}_{0} - Δ R}{{R}_{0} + Δ R}$$

From the above equation, the strain gauge resistance change rate is calculated using the following equation.

$$\begin{matrix}( \frac{{V}_{12}}{{V}_{34}} - 1 ) {R}_{0} - ( \frac{{V}_{12}}{{V}_{34}} + 1 ) Δ R = 0 \\ \frac{Δ R}{{R}_{0}} = \frac{{V}_{12} - {V}_{34}}{{V}_{12} + {V}_{34}}\end{matrix}$$

When the above-expressed relationship is substituted into calculation equation (3) for the curvature radius r described before, the following equation can be obtained.

$$r = \frac{kd}{2} \frac{{R}_{0}}{Δ R} = \frac{k d}{2} \frac{( {V}_{12} + {V}_{34} )}{( {V}_{12} - {V}_{34} )} \qquad ( 4 )$$

The strain gauge sensor device 10 detects the voltage values at one end and the other end of each of the strain gauges G1 to Gn, and calculates the curvature radius r of the circumferential surface of the test object using the difference values (V12 and V34) and the above-provided equation (4). Then, by sequentially calculating the curvature radii at multiple locations on the circumferential surface, the form of the curved portion of the entire circumferential surface can be detected.

Further, according to the strain gauge sensor device 10 of this embodiment, the strain gauges are arranged on front and rear surfaces respectively such that respective pairs face each other, and further they are configured to detect the shape of the curved surface based on the difference value of the measured voltages. With this configuration, even when wiring resistances (Re1 to Re5) exist in the wiring that is routed on the sheet sensor or the intermediate substrate, the device can detect only the resistance changes of the strain gauges without being affected by these wiring resistances. Further, the input of the initial values R0 of the strain resistances of the strain gauges G1 to Gn is no longer necessary, and therefore it is possible to easily perform the calculation of the curvature radius.

The strain gauge sensor device 10 configured as described above can detect the strain state of the test object by detecting the detection value of each of the strain gauges G1 to Gn while either one of the sensor sheets 20A and 20B is attached to the surface of the test object. Furthermore, the detection value of each of the strain gauges G1 to Gn is calculated while the sensor sheets 20A and 20B are attached to a curved surface or wrapped around a cylindrical surface, and therefore it is possible to detect or quantify the curved shape of the surface or the shape of the circumferential surface. When detecting strain of a curved surface using the double-sided strain gauge sensor device 10, the curvature radii of the curved surface are different between each of the strain gauges G1 to Gn on the inner circumferential side and each respective one of the strain gauges G1 to Gn on the outer circumferential side. The detection values of the two strain gauges located at the same position but to face each other also differ from each other. Therefore, by calculating the difference between the detection values of the two strain gauges facing each other, the curved surface shape of the test object can be detected with higher precision.

When the temperature varies partially at the detection position, the detection values of the strain gauges fluctuate. However, by detecting them simultaneously with two opposing strain gauges and taking the difference between the detection values, the influence by temperature changes can be canceled out. Further, even if noise enters the power supply, the same noise is applied to both the strain gauges on the front and rear sides, and therefore by taking the difference between the detection values of these, the influence of noise can be canceled out. With this operation, it is possible to improve the detection accuracy of the sensor.

Furthermore, with the third embodiment as well, advantageous effects similar to those of the first embodiment described above can be obtained.

### Fourth Embodiment

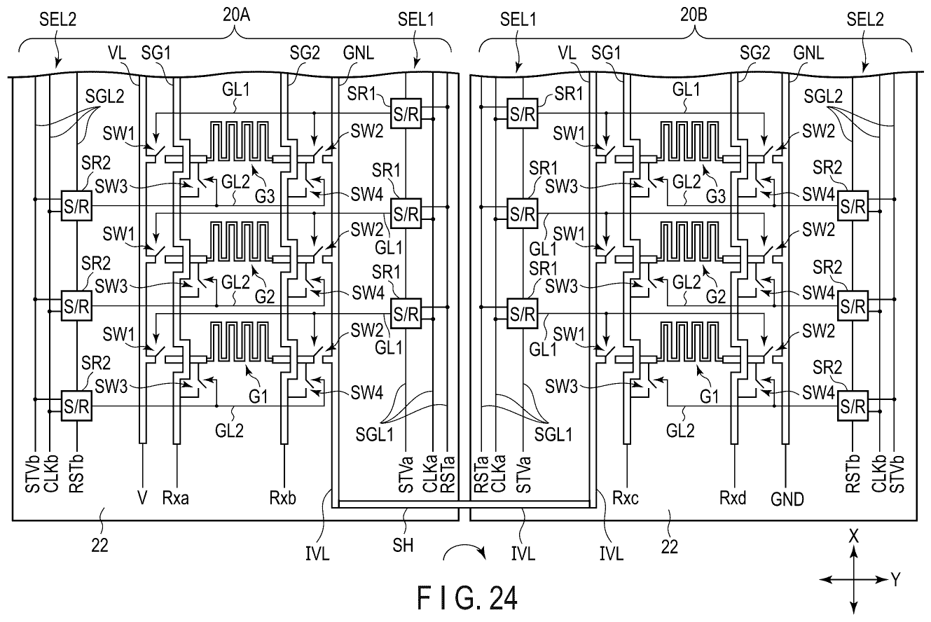

FIG. 24 is a plan view schematically showing a sensor sheet of a strain gauge sensor device according to the fourth embodiment.

As shown in the figure, a double-sided strain gauge sensor device 10 according to the fourth embodiment comprises a first sensor sheet 20A and a second sensor sheet 20B. The wiring structure of the first sensor sheet 20A and the second sensor sheet 20B, as well as the array structure itself of strain gauges G1 to Gn, are the same as those of the sensor sheet 20 in the first embodiment described above. According to the fourth embodiment, the first selector SEL1 and the second selector SEL2 of one sensor sheet, for example, the second sensor sheet 20B are provided in mirror-inverted positions relative to the first selector SEL1 and the second selector SEL2 of the other sensor sheet, for example, the first sensor sheet 20A.

In detail, in the first sensor sheet 20A, the a plurality of shift registers SR1 and signal lines SGL1 that constitute the first selector SEL1 are provided on the side of the ground line GN (intermediate power supply line IVL) with respect to the row of the strain gauges G1 to Gn, and a plurality of shift registers SR2 and signal lines SGL2 that constitute the second selector SEL2 are provided on the side of the power line VL with respect to the row of the strain gauges G1 to Gn.

By contrast, in the second sensor sheet 20B, a plurality of shift registers SR1 and signal lines SGL1 that constitute the first selector SEL1 are provided on the side of the power supply line VL with respect to the row of the strain gauges G1 to Gn, and a plurality of shift registers SR2 and signal lines SGL2 that constitute the second selector SEL2 are provided on the side of the ground line GNL with respect to the row of the strain gauges G1 to Gn.

When the first sensor sheet 20A and the second sensor sheet 20B of the above-described configuration are attached to the surface and rear surface of the base substrate 44, the first selector SEL1 and the second selector SEL2 of the first sensor sheet 20A and the first selector SEL1 and the second selector SEL2 of the second sensor sheet 20B are arranged to respectively face to each other. That is, the wiring lines of the same type are arranged to face each other, respectively, at the same positions. Therefore, it is possible to facilitate the connection between the wiring lines of the first sensor sheet 20A and the second sensor sheet 20B and the wiring lines of the intermediate substrate 12, as well as the routing of the wiring lines, and the like.

In addition, in the fourth embodiment as well, advantageous effects similar to those of the third embodiment described above can be obtained.

### Fifth Embodiment

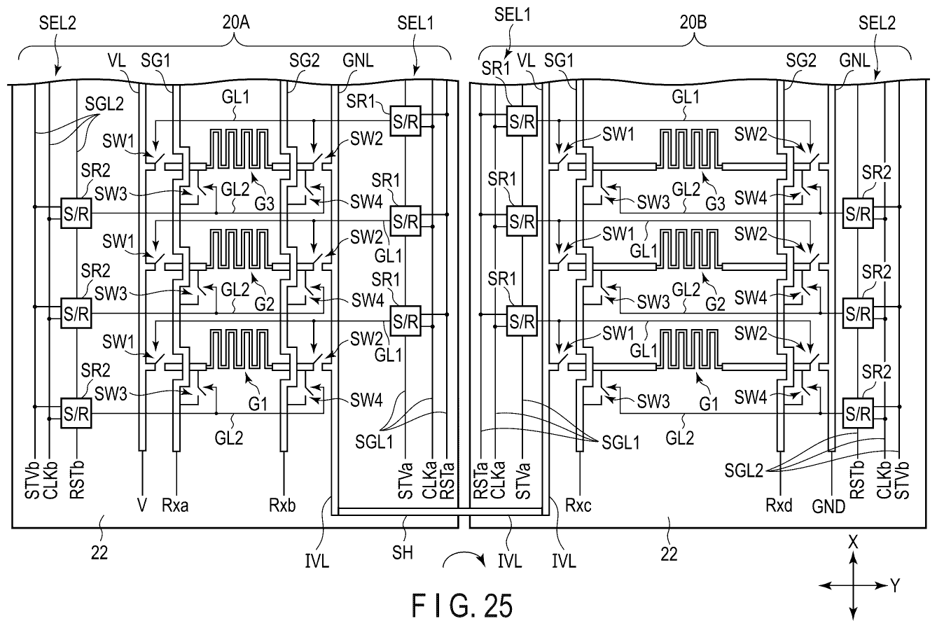

FIG. 25 is a plan view schematically showing a sensor sheet of a strain gauge sensor device according to the fifth embodiment.

As shown in the figure, a double-sided strain gauge sensor device 10 of the fifth embodiment comprises a first sensor sheet 20A and a second sensor sheet 20B. The wiring structure of the first sensor sheet 20A and the second sensor sheet 20B, as well as the array structure, itself, of the strain gauges G1 to Gn are identical to those of the first and second sensor sheets 20A and 20B of the strain gauge sensor device 10 of the fourth embodiment.

According to the fifth embodiment, in one of the first sensor sheet 20A and the second sensor sheet 20B, that is, for example, in the second sensor sheet 20B, the wiring lines are arranged such that the interval between the first signal line SG1 and the second signal line SG2 in the width direction Y, and the interval between the power supply line VL and the ground line GNL in the width direction Y are each wider than that of the corresponding interval on the other one, the first sensor sheet 20A.

In the case of the above-described configuration, when the first sensor sheet 20A and the second sensor sheet 20B are attached to the surface and the rear surface of the base substrate 44, the power supply line VL, the ground line GNL, the first signal line SG1, and second signal line SG2 of the second sensor sheet 20B (four wiring lines in this embodiment) are located such that at least one of these wiring lines is located to be offset in the planar direction relative to the corresponding wiring line of the first sensor sheet 20A without overlapping the corresponding wiring line. With this configuration, the generation of parasitic capacitance between the wiring lines of the surface side and those of the rear surface side can be suppressed, thereby making it possible to improve the sensor response speed.

In addition, in the fifth embodiment as well, advantageous effects similar to those of the third embodiment described above can be obtained.

### Sixth Embodiment

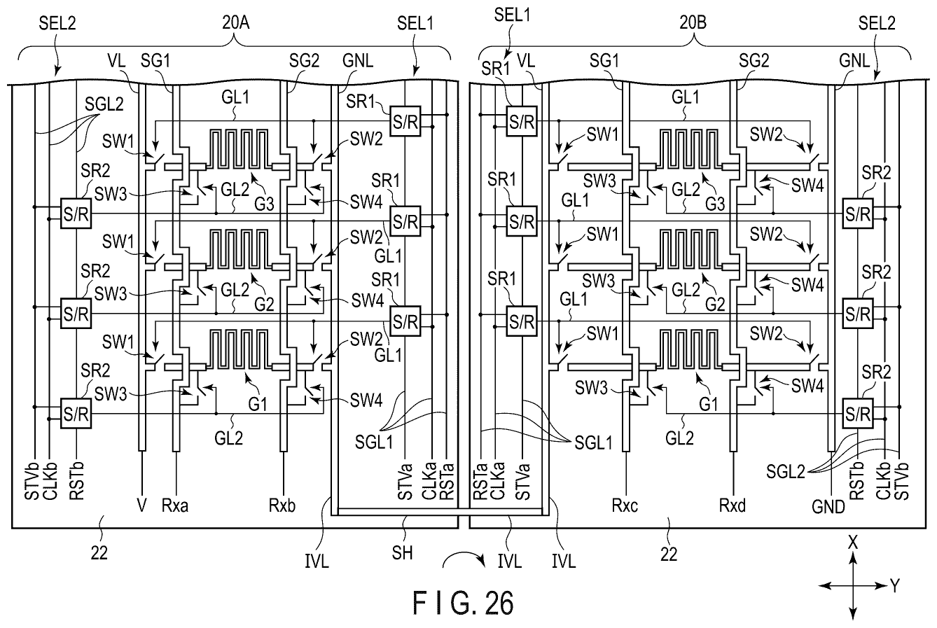

FIG. 26 is a plan view schematically showing a sensor sheet of a strain gauge sensor device according to the sixth embodiment.

As shown in the figure, according to the double-sided strain gauge sensor device 10 of the sixth embodiment, in one of the first sensor sheet 20A and the second sensor sheet 20B, that is, for example, in the second sensor sheet 20B, only the power supply line VL and the ground line GNL are located to be offset in the planar direction relative to the corresponding power supply line VL and ground line GNL (intermediate power line IVL) of the first sensor sheet 20A. The first signal line SG1 and second signal line SG2 of the second sensor sheet 20B are placed to respectively face the first signal line SG1 and second signal line SG2 of the first sensor sheet 20A.

With this configuration in the sixth embodiment as well, the generation of parasitic capacitance between the wiring lines of the surface side and those of the rear surface side can be decreased, and the sensor response speed can be improved. In addition, in the sixth embodiment as well, advantageous effects similar to those of the third embodiment described above can be obtained.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

Based on the configurations described above as embodiments of the invention, a person having ordinary skill in the art may achieve configurations with arbitral design changes; however, as long as they fall within the scope and spirit of the present invention, all of such configurations are encompassed by the scope of the present invention.

For example, the number of strain gauges in the sensor sheet is not limited to that of the above-provided embodiments and may be selected arbitrarily. The selectors (scanner circuits) which selectively open/close the switches each not each limited to a combination of a plurality of shift registers, and multiplexer or the like may as well be used. The constituent materials, dimensions, and shapes of the sensor sheets are not limited to those of the above-provided embodiments, and may be changed as appropriate.

What is claimed is:

1. A strain detection device comprising:
a plurality of strain gauges each having one end and an other end and arranged in a row at intervals;
a power line, a ground line, a first signal line, and a second signal line each extending along the row of the plurality of strain gauges;
a plurality of first open/close switches each connected between the one end of a corresponding one of the plurality of strain gauges and the power supply line;
a plurality of second open/close switches each connected between of the other end of a corresponding one of the plurality of strain gauges and the ground line;
a plurality of third open/close switches each connected between the one end of a corresponding one of the plurality of strain gauges and the first signal line; and
a plurality of fourth open/close switches each connected between the other end of a corresponding one of the plurality of strain gauges and the second signal line.

2. The strain detection device of claim 1, further comprising:
a first selector which selectively opens or closes the first open/close switches and the second open/close switches; and
a second selector which selectively opens or close the third open/close switches and the fourth open/close switches.

3. The strain detection device of claim 2, further comprising:
a controller which selectively executes:
a first operation mode in which the first open/close switches and the second open/close switches are opened and closed sequentially along the row of the strain gauges by the first selector so as to sequentially connect the plurality of strain gauges to the power supply line and the ground line, and in synchronization therewith, the third open/close switches and the fourth open/close switches are opened and closed sequentially along the row of strain gauges by the second selector so as to connect the one end of a corresponding first one of the plurality of strain gauges to the first signal line and so as to connect the other end of the corresponding first one to the second signal line, and
a second operation mode in which, after the first open/close switches and the second open/close switches are switched to close and all of the plurality of strain gauges are connected to the power supply line and the ground line, the third open/close switches and the fourth open/close switches are opened and closed sequentially along the row of strain gauges by the second selector so as to connect the one end of the corresponding first one to the first signal line and so as to connect the other end of the corresponding first one to the second signal line.

4. A strain detection device comprising:
a flexible base material having a first main surface and a second main surface opposing the first main surface;
a first sensor sheet attached to the first main surface;
a second sensor sheet attached to the second main surface, the flexible base material being between the first sensor sheet and the second sensor sheet; and
a controller connected to the first sensor sheet and the second sensor sheet,
wherein
each of the first sensor sheet and the second sensor sheet comprises:
a plurality of strain gauges each having one end and an other end and arranged in a row at intervals; a power line, a ground line, a first signal line, and a second signal line each extending along the row of the plurality of strain gauges; a plurality of first open/close switches each connected between the one end of a corresponding one of the plurality of strain gauges and the power supply line; a plurality of second open/close switches each connected between of the other end of a corresponding one of the plurality of strain gauges and the ground line; a plurality of third open/close switches each connected between the one end of a corresponding one of the plurality of strain gauges and the first signal line; a plurality of fourth open/close switches each connected between the other end of a corresponding one of the plurality of strain gauges and the second signal line; a first selector which selectively opens or closes the first open/close switches and the second open/close switches; and a second selector which selectively opens or close the third open/close switches and the fourth open/close switches, and
a corresponding first one of the plurality of strain gauges of the first sensor sheet are opposed to a corresponding second one of the plurality of strain gauges of the second sensor sheet, the flexible base material being between the corresponding first one and the corresponding second one.

5. The strain detection device of claim 4, wherein
the ground line of the first sensor sheet is electrically connected to the power supply line of the second sensor sheet.

6. The strain detection device of claim 5, wherein
the controller includes a circuit board connected to wiring lines of the first sensor sheet and wiring lines of the second sensor sheet, and the circuit board includes a connection line connecting the ground line of the first sensor sheet and the power supply line of the second sensor sheet.

7. The strain detection device of claim 4, wherein
the first selector of the first sensor sheet faces the first selector of the second sensor sheet, and
the second selector of the first sensor sheet faces the second selector of the second sensor sheet.

8. The strain detection device of claim 4, wherein
at least one of the power line, the ground line, the first signal line, and the second signal line of the first sensor dose not overlap a corresponding one of the power line, the ground line, the first signal line, and the second signal line of the second sensor in a plan view.

9. The strain detection device of claim 4, wherein
the controller comprises:
a first operation mode in which the first open/close switches and the second open/close switches are opened and closed sequentially along the row of the strain gauges by the first selector so as to sequentially connect the plurality of strain gauges to the power supply line and the ground line, and in synchronization therewith, the third open/close switches and the fourth open/close switches are opened and closed sequentially along the row of strain gauges by the second selector, so as to connect the one end of a corresponding first one of the plurality of strain gauges to the first signal line and so as to connect the other end of the corresponding first one to the second signal line, and
a second operation mode in which, after the first open/close switches and the second open/close switches are switched to close and all of the plurality of strain gauges are connected to the power supply line and the ground line, the third open/close switches and the fourth open/close switches are opened and closed sequentially along the row of strain gauges by the second selector so as to connect the one end of the corresponding first one to the first signal line and so as to connect the other end of the corresponding first one to the second signal line, and
controls a first drive of the first sensor sheet in synchronization with a second drive of the second sensor sheet in at least one of the first operation mode and the second operation mode.
